(19) United States
(12) Patent Application Publication
(10) Pub. No.: US 2012/0229435 A1
(43) Pub. Date: Sep. 13, 2012

(54) DISPLAY DEVICE AND ELECTRONIC DEVICE

(75) Inventors: Masahiko HOSHI, Kawasaki (JP); Sonomasa Kobayashi, Kawasaki (JP); Daisuke Mihara, Kawasaki (JP); Kenji Suzuki, Kawasaki (JP)

(73) Assignee: FUJITSU LIMITED, Kawasaki-shi (JP)

(21) Appl. No.: 13/475,156

(22) Filed: May 18, 2012

Related U.S. Application Data
(63) Continuation of application No. PCT/JP2009/070421, filed on Dec. 4, 2009.

(51) Int. Cl. G09G 5/00

(52) U.S. Cl. 345/207

(57) ABSTRACT

A display device includes a display module including a display screen and displaying an image on the display screen; a chassis containing the display module, exposing the display screen, and holding the display screen so as to stand the display screen; a light receiving window disposed on a first part on the chassis, the first part being adjacent to a second part where the display screen is exposed, shifted toward a back side from a surface of the chassis on a periphery of the second part, and receiving incident light from outside of the chassis into the chassis; and an illumination sensor contained in the chassis, detecting illuminance of incident light through the light receiving window, and having an illuminance detection range having a center line extending in a direction inclined downward from a direction of a normal line of the display screen.

### CROSS-REFERENCE TO RELATED APPLICATION

This application is a continuation application filed under 35 USC 111(a) claiming benefit under 35 USC 120 and 365(c) of PCT Application JP2009/070421 filed Dec. 4, 2009, the entire contents of which are incorporated herein by reference.

### FIELD

The embodiments discussed herein are related to a display device displaying an image and an electronic device including the display device.

### BACKGROUND

In recent years, more and more laptop personal computers (hereinafter may be simplified as a “laptop PC”) have been widely used. The laptop PC generally includes a main body device and a display device so that the display device is openably and closeably connected to the main body device.

The main body device performs processes on various data, and the display device displays an image and a character image on the display screen of the display device.

In the laptop PC, a liquid crystal panel is generally used as the display device. Further, in most display devices including the liquid crystal panel, the brightness of the displayed image on the display device may be adjusted in accordance with the environmental illuminance to reduce power consumption and improve the visibility of the displayed image.

In such a display device, an illuminance sensor is included in the display device to detect the environmental illuminance (see, for example, Japanese Laid-open Patent Application Nos. 06-11713 and 2002-277872).

### SUMMARY

According to an aspect of the present application, a display device includes a display module, a chassis, a light receiving window, and an illumination sensor.

The display module includes a display screen and displays an image on the display screen.

The chassis contains the display module, exposes the display screen, and holds the display screen so as to stand the display screen.

The light receiving window disposed on a first part on the chassis, the first part being adjacent to a second part where the display screen is exposed, shifted toward a back side from a surface of the chassis on a periphery of the second part, and receives incident light from outside of the chassis into the chassis.

The illumination sensor is contained in the chassis, detects illuminance of incident light through the light receiving window, and has an illuminance detection range having a center line extending in a direction inclined downward from a direction of a normal line of the display screen.

According to another aspect of the present application, an electronic device includes the display device and a main body device to which the display device is openably and closeably connected.

The objects and advantages of the embodiments disclosed herein will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a perspective view of a laptop PC according to an embodiment in an opened state of the laptop PC;

FIG. 2 is a perspective view of the laptop PC in a closed state of the laptop PC;

FIG. 3 is a perspective view of the laptop PC in the closed state when viewed from a back surface side;

FIG. 4 is a perspective view of the laptop PC in the closed state when viewed from a rear surface side;

FIG. 5 is a cross-sectional view of the laptop PC when cut along the line CC of FIG. 1;

FIG. 6 is an enlarged cross-sectional view of a rectangular area D of FIG. 5;

FIGS. 7A and 7B are perspective views illustrating enlarged window parts;

FIG. 8 is a schematic view of a laptop PC according to a first comparative example;

FIG. 9 is a drawing illustrating a light receiving window disposed at another position according to another example;

FIG. 10 is a drawing illustrating a relative positional relationship between the light receiving window and a light receiving surface of an illuminance sensor in another example;

FIG. 11 is a drawing illustrating the relative positional relationship between the light receiving window and the light receiving surface of the illuminance sensor in still another example;

FIG. 12 is a schematic view of a laptop PC according to a second comparative example;

FIG. 13 is an enlarged view of an inclined surface adjacent to a sub screen;

FIG. 14 is a cross-sectional view of a surrounding structure of a storage part storing an operation pen when cut along the line H-H of FIG. 2 when the laptop PC is closed;

FIG. 15 is a perspective view of a main body device in a state where a display device is removed so that plural air inlet ports formed on an inclined back surface of the main body device are exposed;

FIG. 16 is a perspective view of the laptop PC in a state where the plural air inlet ports on the inclined back surface are hidden by the display device;

FIG. 17 is a cross-sectional view of an area near the air inlet ports on the inclined back surface when cut along the line J-J of FIG. 16;

FIG. 18 is an enlarged perspective view illustrating the light receiving window formed on an inclined surface of the main body device;

FIG. 19 is an enlarged view of an area B defined by the dotted line of FIG. 1;

FIG. 20 is a perspective view illustrating an internal structure of an area near the light receiving window;

FIG. 21 is a top view illustrating the internal structure of the area near the light receiving window;

FIG. 22A is a perspective view of a light guiding member alone when viewed from a Light Emitting Diode (LED) substrate side;

FIGS. 22B through 22D are perspective views illustrating corresponding parts of the light guiding member;

FIG. 23 is a perspective view illustrating light emitting windows according to a third comparative example;

FIG. 24 is a perspective view of an internal structure in an area near the light emitting windows in the third comparative example;

FIG. 25 is a top view of the internal structure in the area near the light emitting windows in the third comparative example;

FIG. 26 is a perspective view of the internal structure in the area near the light guiding member after an LED substrate is removed to make the light guiding member more visible;

FIG. 27 is an enlarged view of air outlet ports formed on an inclined surface and air outlet ports formed on a back surface

FIG. 28 is a cross-sectional view of an area near inclined-surface air outlet ports when cut along the line K-K passing through a first rib in FIG. 27;

FIG. 29 is a cross-sectional view of an area near back-surface air outlet ports when cut along the line L-L passing through a second rib in FIG. 27.

FIG. 30 is a view illustrating air outlet ports according to a fourth comparative example;

FIG. 31 is a perspective view illustrating a part near an ODD of FIG. 1;

FIG. 32 is a drawing illustrating the laptop PC in a state where a disc tray is ejected to the outside of a main body chassis after a pressing button is pressed;

FIG. 33 is an enlarged view of a part near the pressing button of FIGS. 31 and 32;

FIG. 34 is a cross-sectional view of the pressing button when cut along the line M-M of FIG. 33;

FIG. 35 is a cross-sectional view of the pressing button according to a fifth comparative example similar to FIG. 34;

FIG. 36 is a drawing illustrating another example of a concave part formed by a second side surface of a cover and a pressing surface;

FIG. 37 is a drawing illustrating an inside of the main body device in which no ODD is mounted;

FIG. 38 is a drawing where the ODD is moved into the main body device;

FIG. 39 is an enlarged view of a part including a guiding member of FIGS. 37 and 38; and

FIG. 40 is a schematic view illustrating where a cable is held by an extending part of the guiding member and the ODD is inserted into the main body chassis.

### DESCRIPTION OF EMBODIMENTS

In the display device including an illuminance sensor, the illuminance sensor may receive (detect) excessive direct outer light such as light from indoor lighting or the like depending on the position (posture) of the display device. In this case, the detected environmental illuminance may become greater than the environmental illuminance that is the actual (correct) detected value.

As a result, the brightness of the displayed image may not be adjusted in accordance with the actual environmental illuminance and the visibility of the displayed image may be degraded.

Embodiments described herein are provided in light of the problem described above, and may provide a display device displaying an image in appropriate brightness and an electronic device including the display device.

In the following, specific embodiments of basic configurations according the present application are described with reference to the accompanying drawings.

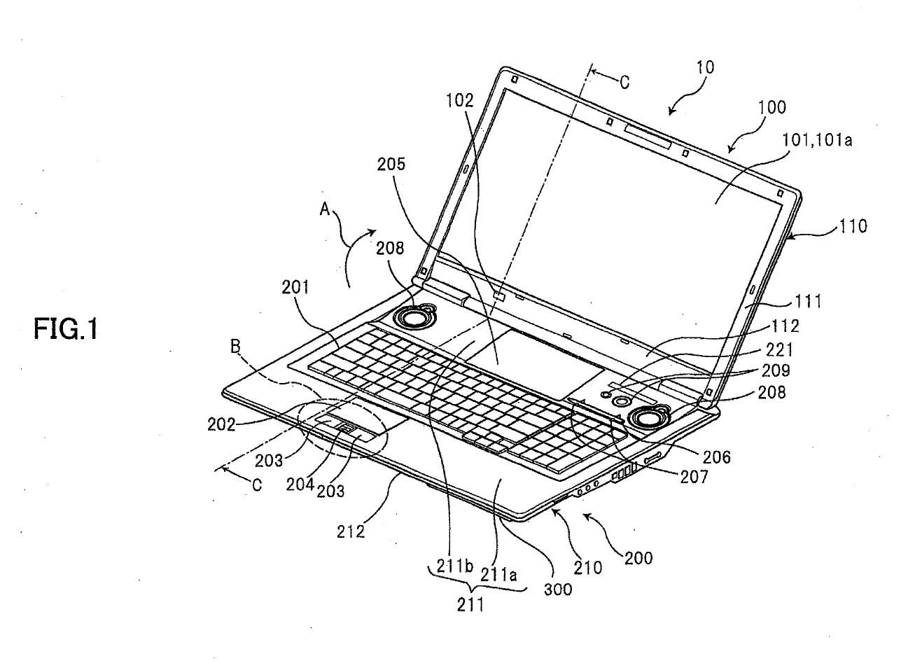

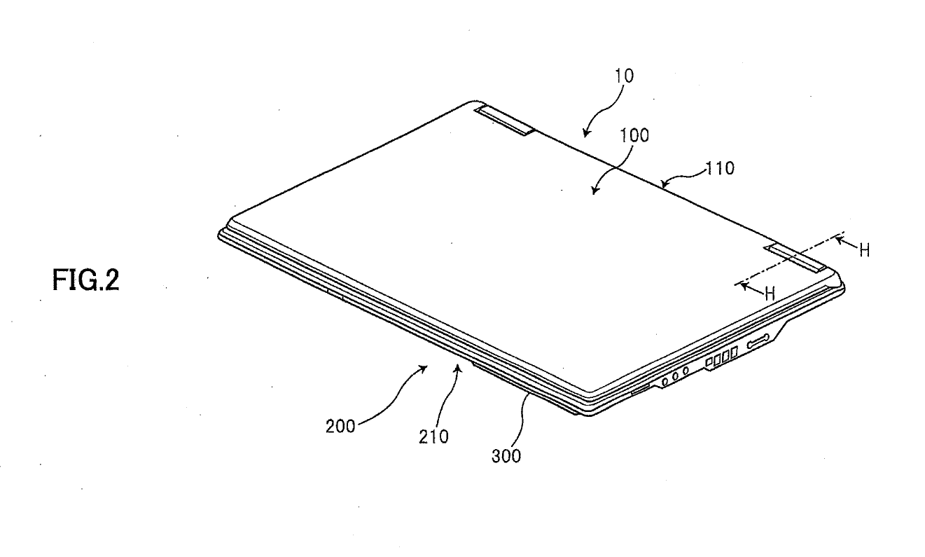

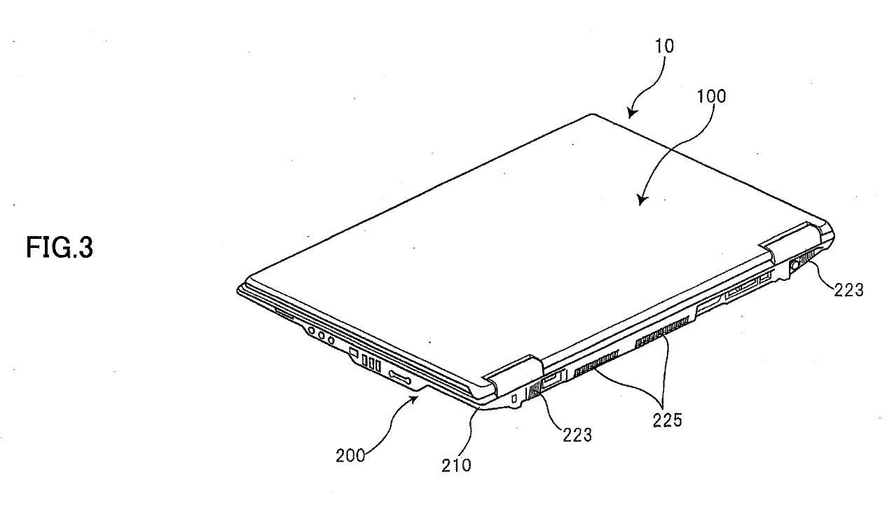

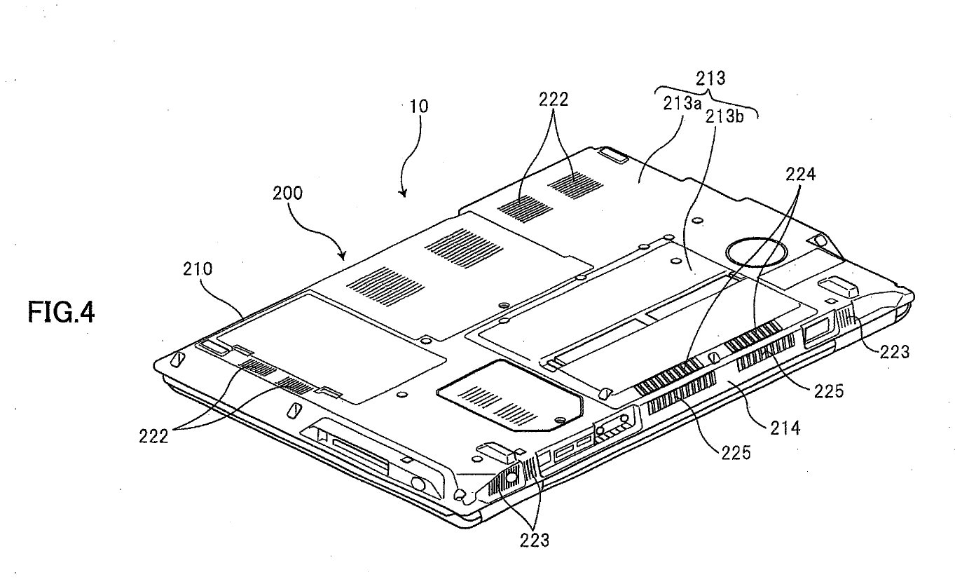

FIG. 1 is a perspective view of a laptop PC according to a specific embodiment of a basic configuration in an opened state of the laptop PC. FIG. 2 is a perspective view of the laptop PC in a closed state of the laptop PC. Further, FIG. 3 is a perspective view of the laptop PC in the closed state when viewed from a back surface side. Further, FIG. 4 is a perspective view of the laptop PC in the closed state when viewed from a rear surface side.

The laptop PC 10 of those figures includes a display device (display section) 100 and a main body device (main body part) 200. Further, the display device 100 is openly and closely connected to the main body device 200 in a manner such that display device 100 rotates in the arrow A direction (FIG. 1) relative to the main body device 200.

FIG. 1 illustrates the laptop PC 10 in a state where the display device 100 is opened relative to the main body device 200 (herein may be referred to as the “opened state”). On the other hand, FIGS. 2 through 4 illustrates the laptop PC 10 in a state where display device 100 is closed relative to the main body device 200 (herein may be referred to as the “closed state”).

In the display device 100, a liquid crystal panel 101 is contained in a display chassis 110 so that a display screen 101a is exposed.

Due to the display chassis 110, when the laptop PC 10 is in the opened state, the liquid crystal panel 101 stands and is held by the display chassis 110 so that the display screen 101a faces a user. Further, the display chassis 110 includes a front surface that faces the user when the laptop PC 10 is in the opened state. The front surface of the display chassis 110 includes a first surface part 111 and a second surface part 112 which are described below.

The first surface part 111 is a surface facing the direction parallel to the normal line direction of the display screen 101a. Namely, the surface of the first surface part 111 is parallel to the surface of the display screen 101a. The second surface part 112 is disposed on the lower side of the display screen 101a, and is included to face downward relative to the normal line direction of the display screen 101a.

Further, the lower end of the second surface part 112 is disposed on the back side (opposite to the user side) of the display device 100 when compared with the lower end part of the display screen 101a. In this embodiment, the second surface part 112 is inclined toward the back side of the display device 100 by approximately 30 degrees relative to the first surface part 111. The front surface including the first surface part 111 and the second surface part 112 circumferentially surrounds the display screen 101a.

Here, in the display device 100, the brightness of an image displayed on the display screen 101a is automatically adjusted in accordance with the environmental illuminance of the laptop PC 10. To that end, a light receiving window 102 to receive environmental light of the laptop PC 10 into the display chassis 110 is formed on the second surface part 112 as a part of the second surface part 112.

Further, an illuminance sensor to detect the illuminance of the environmental light incident through the light receiving window 102 is contained on the back side of the light receiving window 102 in the display chassis 110. Details of the illuminance sensor are described below.

When the laptop PC 10 is in the opened state, the main body device 200 is disposed on the front side (not back side) of the display screen 101a relative to the display device 100. In other words, the main body device 200 is disposed on the user side relative to the display device 100 when the laptop PC 10 is in the opened state.

The main body device 200 includes a main body chassis 210 containing an Optical Disk Drive (ODD) 300 and various circuits, the ODD 300 driving an optical disk serving as a portable medium, the various circuits including an information processing circuit generating information to be displayed on the display screen 101a and the like.

The main body chassis 210 includes an upper surface 211 which is covered by the display device 100 when the laptop PC 10 is in the closed state. The upper surface 211 includes a basic flat surface 211a and an inclined surface 211b, which are described below. The basic flat surface 211a occupies more than half of the upper surface 211, and is a substantially horizontal surface when the laptop PC 10 is in (normal) use.

Further, the inclined surface 211b is formed next to the basic flat surface 211a and disposed on a side of the connecting section between the main body device 200 and the display device 100 relative to the basic flat surface 211a. Namely, the inclined surface 211b is disposed between the basic flat surface 211a and the connecting section between the main body device 200 and the display device 100.

Further, the inclined surface 211b is inclined relative to the basic flat surface 211a so that the inclined surface 211b faces toward the user side. To that end, the end on the front side (user side) of the inclined surface 211b is lowered toward the inside of the main body device 200 so as to be lower than the basic flat surface 211a. In this embodiment, the inclined surface 211b is inclined forward by approximately 30 degrees relative to the basic flat surface 211a.

The main body device 200 includes a keyboard 201, a track pad 202, right and left click buttons 203, and a fingerprint sensor 204 for fingerprint authentication, which are formed on the basic flat surface 211a.

Further, in the main body device 200, a sub screen 205 corresponding to the display screen 101a is formed as a part of the inclined surface 211b. The sub screen 205 serves also as an input operation surface that detects an input operation performed on the input operation surface. Further, due to the inclination of the inclined surface 211b, a storage part 207 storing an operation pen (touch pen) 206 is formed on a part of the inclined surface 211b.

For example, when the input operation surface of the sub screen 205 detects a touch to the input operation surface, the operation pen 206 may be a simple rod-like plastic body. Further, when the input operation surface of the sub screen 205 employs an infrared method, such a plastic body may also be used as the operation pen 206.

On the other hand, when the input operation surface of the sub screen 205 is a detection device using an electromagnetic induction method, an electronic pen may be used as the operation pen 206. Namely, the operation pen 206 is an example of an operation body, and an appropriate type of the operation pen 206 may be selected depending on the type of the input operation surface of the sub screen 205.

Further, on the inclined surface 211b, there are two speakers 208 provided on the respective both sides of the sub screen 205. Further, on the right side of the sub screen 205 in FIG. 1, various types of operation buttons 209 and a camera 221 are provided.

Further, on a front surface 212 of the main body chassis 210, there are plural light emitting windows formed on an area B defined by a dotted line in FIG. 1. The plural light emitting windows indicate statuses of the laptop PC 10 using light emitted by a Light Emitting Diode (LED), the state including, for example, a charging state. Details of the plural light emitting windows are described below.

Further, in the main body device 200, heat generated while various circuits in the main body device 200 are operating is discharged to the outside of the main body device 200 by an air flow from the inside to the outside of the main body device 200. To that end, the main body device 200 includes a fan to generate the air flow and a radiator transferring heat from various parts in the main body device 200 to the air flow.

Further, a bottom surface 213 of the main body device 200 includes a first bottom surface part 213a and a second bottom surface part 213b. The first bottom surface part 213a occupies more than half of the bottom surface 213. The second bottom surface part 213b corresponds to a wall of a containing space containing the radiator and the like.

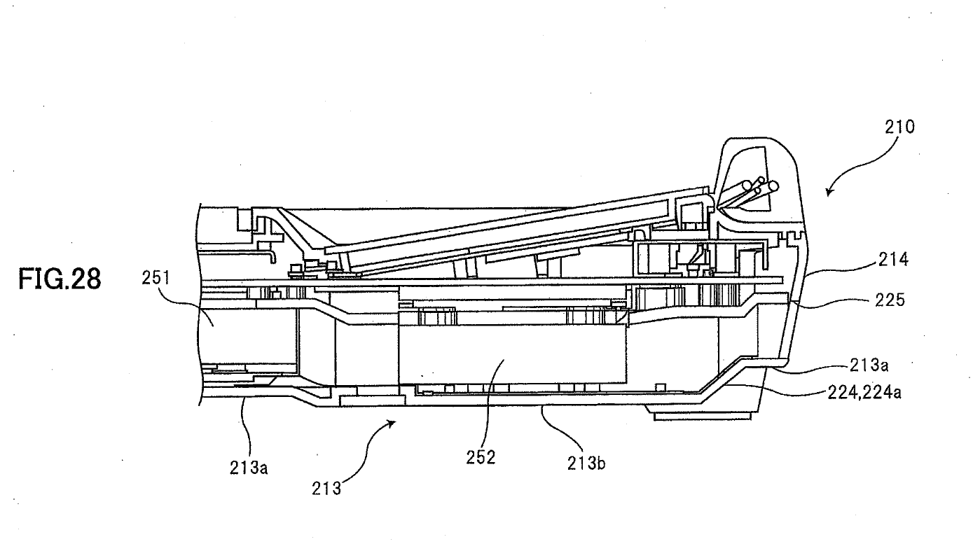

The second bottom surface part 213b is disposed (formed) on the outer side (lower side) of the main body chassis 210 when compared with the first bottom surface part 213a (see FIG. 28). By doing this, more space is generated for the containing space containing the radiator and the like in the main body chassis 210.

Further, plural bottom-surface air input ports 222 are formed on the first bottom surface part 213a of the main body chassis 210. Further, plural back-surface air inlet ports 223 are formed on a back surface 214 of the main body chassis 210.

Further, two inclined-surface air outlet ports 224 are formed on an inclined surface formed from the second bottom surface part 213b to the back surface 214. Further, two back-surface air outlet ports 225 are formed on the back surface 214 of the main body chassis 210. Namely, the inclined-surface air outlet ports 224 and the back-surface air outlet ports 225 are formed (vertically) side by side on outer surfaces of the main body chassis 210.

Further, each of the air inlet and outlet ports is divided into plural openings by plural ribs.

The laptop PC 10 has an exterior appearance as described with reference to FIGS. 1 though 4.

Next, details of a surrounding structure of the light receiving window 102 on the display device 100 are described.

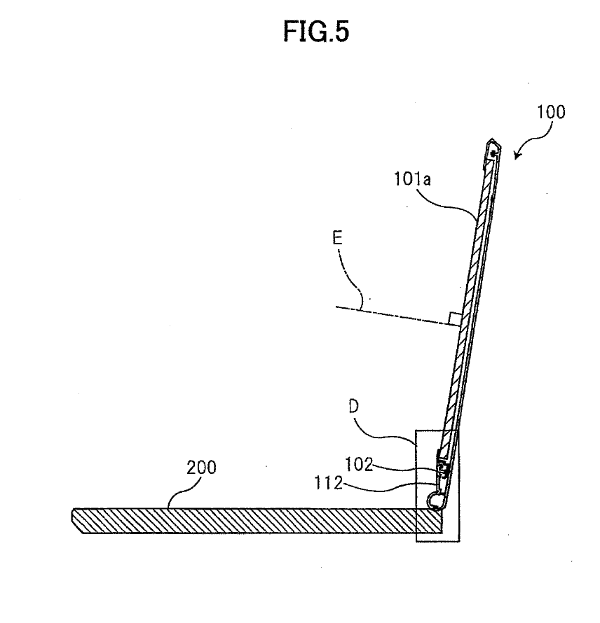

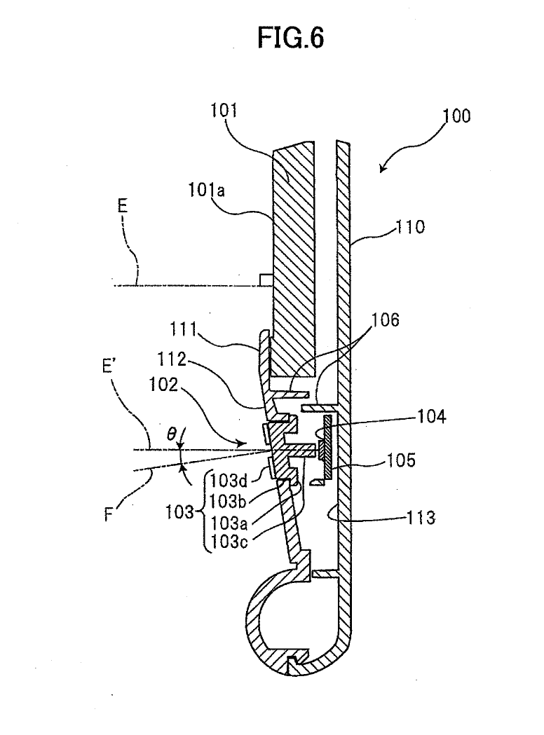

FIG. 5 is a cross-sectional view of the laptop PC when cut along the line CC of FIG. 1. FIG. 6 is an enlarged cross-sectional view of a rectangular area D of FIG. 5.

In FIG. 5, elements that are unrelated to the surrounding structure of the light receiving window 102 and that are included in an inner structure of the main body device 200 may be omitted. Further, in FIG. 6, even the main body device 200 is not described.

As described above, the light receiving window 102 is disposed on the lower side of the display screen 101a, and is included (integrated) as a part of the second surface part 112 inclined downward relative to the normal line direction E of the display screen 101a.

Further, as may be apparent from FIG. 6, the light receiving window 102 is a part of a surface of a window part 103. The window part 103 is engaged in an opening formed at the position described below of the second surface part 112.

The display screen 101a is circumferentially surrounded by the first surface part 111 having a frame (U) shape and the second surface part 112, so that the display screen 101a is exposed from the display chassis 110. Namely, the first surface part 111 is formed as an outer surface of the display chassis 110 as the edge of the part where the display screen 101a is exposed. Further, on the second surface part 112, the opening where the window part 103 is engaged in is formed at the position shifted to the back side (i.e., opposite to the user side) relative to the outer surface at the edge (i.e., the first surface part 111).

Then, a sensor substrate 105, on which an illuminance sensor 104 detecting the illuminance of light incident through the light receiving window 102 is mounted, is fixed to a position on an inner wall surface 113 on the back surface side of the display chassis 110, the position corresponding to the back side of the window part 103. The inner wall surface 113 on the back surface side of the display chassis 110 is substantially parallel to the display screen 101a.

Therefore, the normal line E′ of the illuminance sensor 104 is substantially parallel to the normal line E of the display screen 101a. In the periphery of the sensor substrate 105, plural ribs 106 are formed to prevent the light from the liquid crystal panel 101 from entering into the periphery of the illuminance sensor 104.

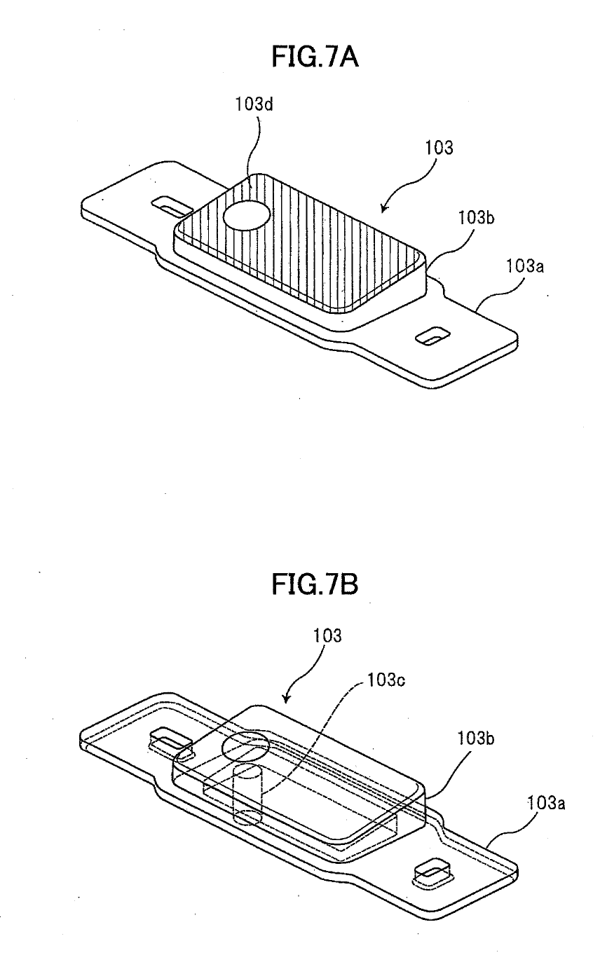

FIGS. 7A and 7B are perspective views illustrating details of the window part 103.

Specifically, FIG. 7A is a perspective view of an exterior of the window part 103. FIG. 7B is a transparent perspective view of the window part 103.

The window part 103 includes a flange 103a to fix the window part 103 to the display chassis 110 and a protrusion part 103b that is engaged into an opening of the second surface part 112 and exposed to the outside.

The window part 103 includes a light guiding body 103c extending from an area that faces the illuminance sensor 104 of FIG. 6 when the protrusion part 103b is engaged into the opening, the area being a part of the rear surface opposite to the surface exposed to the outside of the protrusion part 103b, toward the illuminance sensor 104. Details of the light guiding body 103c are described below.

In this embodiment, the light receiving window 102 is included in a part of the second surface part 112. Therefore, the display screen 101a is also inclined downward relative to the normal line direction E of the display screen 101a. Namely, a normal line F of the display screen 101a is shifted (rotated) downward relative to the normal line E of the display screen 101a by a declination angle θ.

As a result, through the light receiving window 102, the light incident in the direction shifted by the declination angle θ relative to the normal line direction E of the display screen 101a is mainly received in the display chassis 110.

On the other hand, the normal line E′ of the illuminance sensor 104 is substantially parallel to the normal line E of the display screen 101a. Therefore, to accurately detect the illuminance by the illuminance sensor 104, it is desired that light is incident along the normal line E′ of the illuminance sensor 104 to a light receiving surface of the illuminance sensor 104.

To that end, the light guiding body 103c has a role to bend and uniformly direct the incident light from an incident range having a main direction shifted as described above to and into the direction along the normal line E′ of the illuminance sensor 104. Namely, various directions of light incident into the light guiding body 103c are unified to the direction along the normal line E′ of the illuminance sensor 104 while the light travels in the light guiding body 103c. The light guiding body 103c delivers the light having uniform direction to the illuminance sensor 104.

The light guiding body 103c cylindrically extends and has a sufficient length from the area facing the illuminance sensor 104 of FIG. 6 when the protrusion part 103b is engaged in the opening near the illuminance sensor 104.

The window part 103 described above may be integrally formed of a colorless and transparent resin material.

Further, on the surface exposed outside (corresponding to the light receiving window 102) of the protrusion part 103b but excluding a circular area corresponding to the beginning of the light guiding body 103c, a black screen 103d is formed by printing.

Due to the black screen 103d, the incident range of the incident light is limited by the circular hole corresponding to the circular area. Then, the light incident through the circular hole is guided by the light guiding body 103c and delivered to the light receiving surface of the illuminance sensor 104 along the normal line E′ of the light receiving surface.

Next, a first comparative example is described to be compared with a configuration in this embodiment.

In the laptop PC of the first comparative example, the positions where the light receiving window and the illuminance sensor are disposed and the shape of the peripheral of the light receiving window differ from those of the laptop PC 10 in this embodiment.

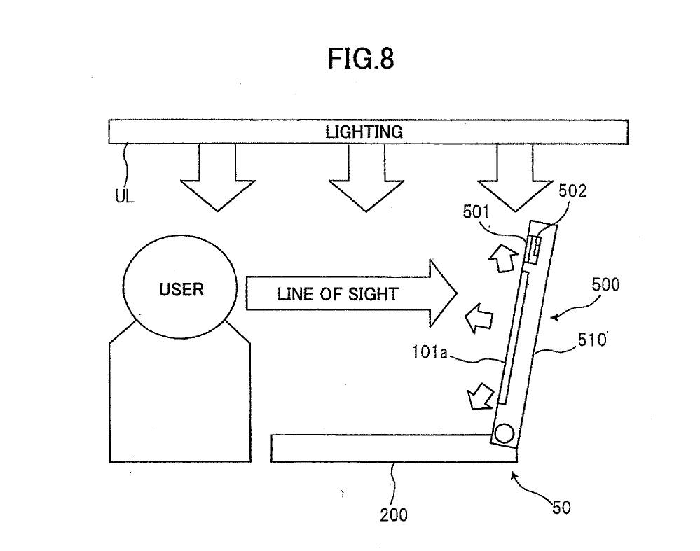

FIG. 8 is a schematic view of the laptop PC according to the first comparative example.

In FIG. 8, the same reference numerals are used to describe the same or equivalent elements in the configuration of the laptop PC 10 in this embodiment as illustrated in FIG. 1 and the like, and the repeated description thereof may be omitted.

In the display device 500 of a laptop PC 50 in the first comparative example, a light receiving window 501 and an illuminance sensor 502 are disposed on the upper side of the display screen 101a. Further, the entirety of a front surface of a display chassis 510 is substantially a flat surface along the display screen 101a. Further, the light receiving window 501 is integrated (included) as a part of the front surface.

Namely, in the laptop PC 50 in the first comparative example, the light receiving window 501 faces in the direction substantially the same as that of the normal line of the display screen 101a. Further, the illuminance sensor 502 is fixed to the inner wall surface on the back surface side of the display chassis 510, the position on the inner wall surface corresponding to the position back side of the light receiving window 501.

In the laptop PC 50 having the configuration described above in the first comparative example, the light receiving window 501 is more likely to receive not only light incident in the direction parallel to the direction along which the user may see the display screens but also additional light including direct and reflected light from a ceiling light UL and diffracted light from the display screen 101a.

As a result, the illuminance sensor 502 is more likely to detect an illuminance value higher than an illuminance value that is the actual detected value. In such a case, the brightness of a displayed image may not be appropriate in accordance with the environmental illuminance. As a result, the visibility of the displayed image for the user may be degraded (impaired).

On the other hand, unlike the first comparative example, in the laptop PC 10 in this embodiment, the light receiving window 102 is disposed at the position shifted toward the back side from the surface of the display chassis 110 at the edge of the area where the display screen 101a is exposed. In addition, due the inclination of the light receiving window 102 as described above, a detection range to detect the illuminance of light by the illuminance sensor 104 is directed downward when compared with a case where the range is determined based on the normal line E of the display screen 101a as the center of the range.

As a result, it may become possible to reduce the incidence of the light from the ceiling light UL and the display screen 101a. Therefore, the illuminance sensor 104 may detect the illuminance of the light received mainly from the direction in which the user sees the display screen 101a. By doing this, the illuminance detected by the illuminance sensor 104 may become the illuminance that is to be detected originally (essentially). Accordingly, it may become possible for the display device 100 of the laptop PC 10 to display an image at an appropriate brightness level.

Further, in this embodiment, the front surface of the display chassis 110 includes the second surface part 112 which is inclined downward relative to the normal line E described above and which has the lower end shifted to the back side from the display screen 101a. Further, the light receiving window 102 is integrated as a part of the second surface part 112.

In this embodiment, by having the structure described above, the receiving window 102 is inclined, so that the incidence of the light from the ceiling light UL and the display screen 101a into the light receiving window 102 may be effectively reduced (controlled).

Further, in this embodiment, the light receiving window 102 is disposed on the lower side of the display screen 101a. Therefore, it may become possible to more effectively reduce the incidence of the light from the ceiling light UL and the display screen 101a in the light receiving window 102.

Further, in this embodiment, due to the black screen 103d on the light receiving window 102, the incident range of the incident light may be limited to the circular hole of the black screen 103d. As a result, it may become possible to more effectively reduce the incidence of the light from the ceiling light UL and the display screen 101a in the light receiving window 102.

Further, in this embodiment, the incident light received by the light receiving window 102 inclined as described above is guided to the illuminance sensor 104 via the light guiding body 103c. In this case, as described above, the direction of the incident light is bent and uniformly directed so that the incident light may be incident on the light receiving surface of the illuminance sensor 104 at a desired direction which is along the direction of the normal line of the light receiving surface of the illuminance sensor 104. As a result, it may become possible to accurately detect the illuminance by the illuminance sensor 104.

In this embodiment, a case is described where the light receiving window 102 is integrated as a part of the second surface part 112 inclined relative to the first surface part 111. However, the installation manner (configuration) of the light receiving window 102 is not limited to the above case. For example, the light receiving window 102 may have the configuration (another example) described below.

FIG. 9 is a drawing illustrating another example of the installation (configuration) of the light receiving window.

In this example, the periphery of the installation position of the light receiving window 102 is locally shifted to the back side from the surface of the display chassis 110 at the edge of the area where the display screen 101a is exposed, so that a concave part is formed. Further, the light receiving window 102 is integrated as a part of the bottom surface part 112′ of the concave part.

In this example as well, similar to this embodiment, it may become possible to reduce the incidence of the light from the ceiling light UL and the display screen 101a in the light receiving window 102.

Further, in this embodiment, a case is described where in the relative positional relationship between the light receiving window 102 and the light receiving surface of the illuminance sensor 104, the corresponding normal lines F and E′ are shifted from each other by the declination (difference) angle θ, and the difference is corrected by the light guiding body 103c.

However, the relative positional relationship between the light receiving window 102 and the light receiving surface of the illuminance sensor 104 is not limited to the case. For example, the relative positional relationship may have the configuration (another example) described below.

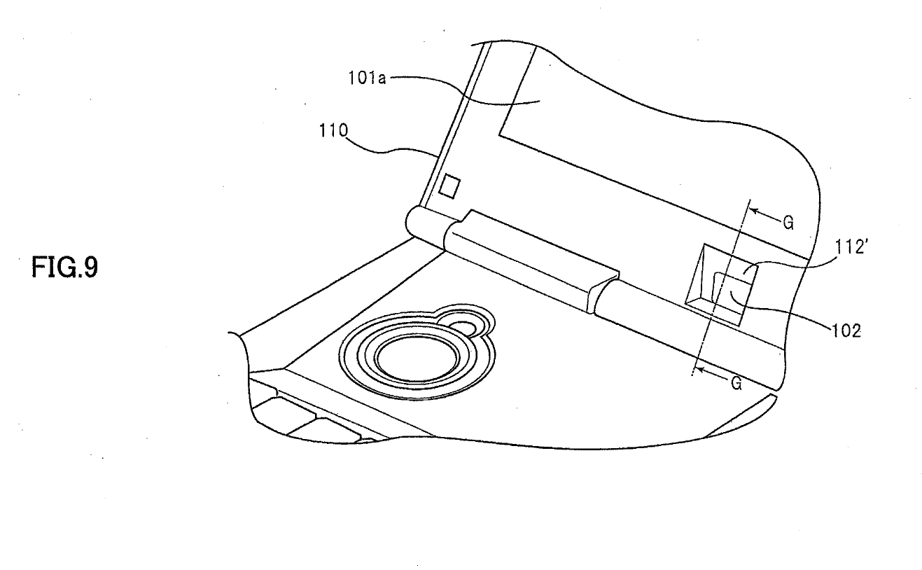

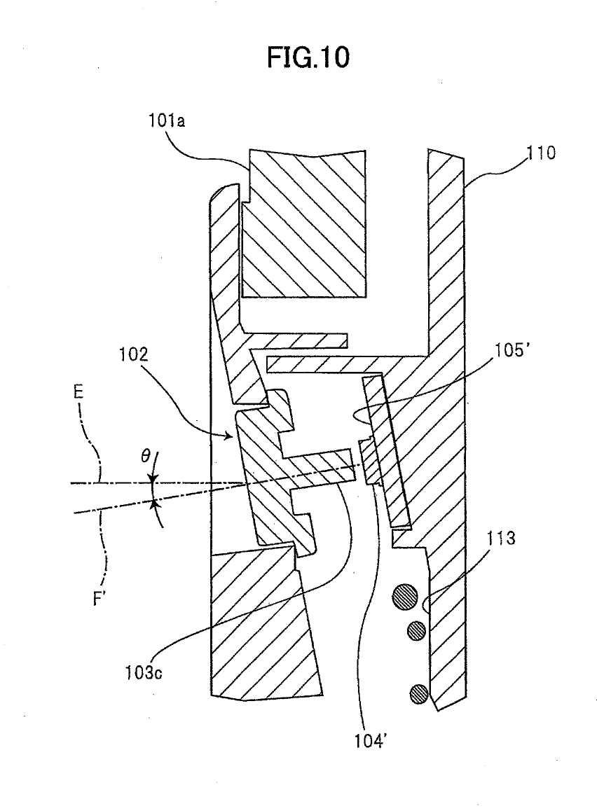

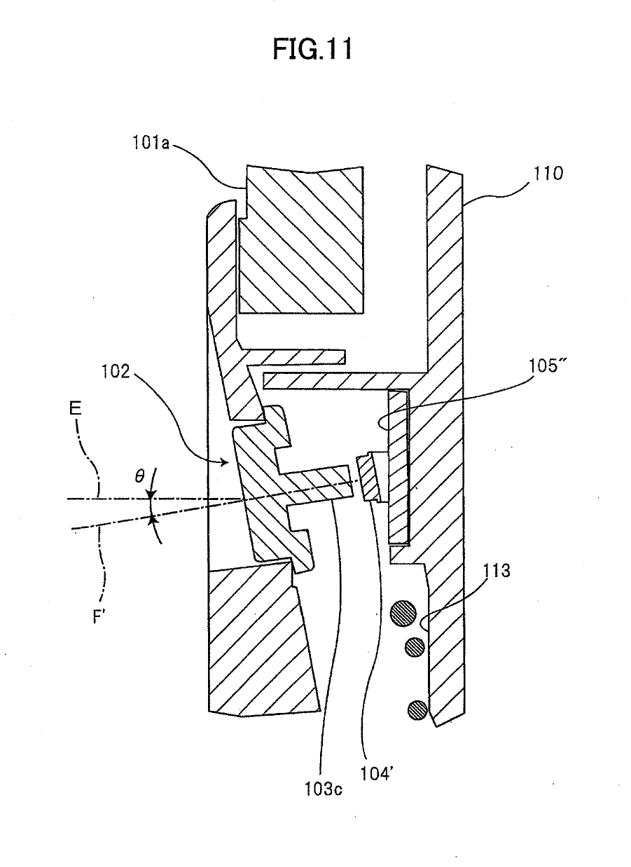

FIG. 10 is a drawing illustrating the relative positional relationship between the light receiving window 102 and the light receiving surface of the illuminance sensor 104 in another example. Further, FIG. 11 is a drawing illustrating the relative positional relationship between the light receiving window 102 and the light receiving surface of the illuminance sensor 104 in still another example.

FIGS. 10 and 11 are cross-sectional views when cut along the line G-G in FIG. 9 and illustrate cases in which the illuminance sensor is installed in two manners different from each other.

In both of the two examples, the light receiving window 102 is substantially parallel to the light receiving surface of the illuminance sensor 104′. Further, the direction of the normal line F′ of the light receiving window 102 and the receiving surface of the illuminance sensor 104′ is shifted downward relative to the direction of the normal line E of the display screen 101a by the declination (difference) angle θ.

In those examples, the incident light along the normal line F′ of the light receiving window 102 is further incident on the light receiving surface of the illuminance sensor 104′ without being bent in the light guiding body 103c. As described above, the light receiving window 102 is substantially parallel to the light receiving surface of the illuminance sensor 104′; therefore, the incident direction to the light receiving surface directly becomes a desired incident direction which is along the normal line of the light receiving surface.

In the example of FIG. 10, a sensor substrate 105′ on which the illuminance sensor 104′ is mounted is fixed to the inner wall surface 113 of the display chassis 110 in a manner that the sensor substrate 105′ is inclined relative to the inner wall surface 113. In this case, the sensor substrate 105′ is inclined so that the direction of the normal line of the light receiving surface of the illuminance sensor 104′ on the sensor substrate 105′ is substantially the same as the direction of the normal line F′ of the light receiving window 102.

On the other hand, in the example of FIG. 11, a sensor substrate 105″ is fixed to the inner wall surface 113 of the display chassis 110 in a manner that the sensor substrate 105″ is placed (disposed) along the inner wall surface 113. Instead, the illuminance sensor 104′ is mounted on the sensor substrate 105″ in a manner that the illuminance sensor 104′ is inclined relative to the sensor substrate 105″.

Further, the illuminance sensor 104′ is inclined so that the direction of the normal line of the light receiving surface of the illuminance sensor 104′ is substantially the same as the direction of the normal line F′ of the light receiving window 102.

In the examples described with reference to FIGS. 10 and 11 as well, obviously, an image may be displayed at an appropriate brightness level similar to this embodiment.

Further, in this embodiment, a case is described where the black screen 103d is provided on the light receiving window 102. However, when the size of the light receiving window 102 is sufficiently small, the black screen 103d may not be used.

Further, in this embodiment, the window part 103 is used. However, it may become possible to obtain a similar effect without using the window part 103. For example, without using the window part 103, the illuminance sensor 104 or the sensor substrate 105 may be mounted inclined on the display chassis 110 in a manner that the direction of the normal line (i.e., the center of a detection range) of the light receiving surface of the illuminance sensor 104 is inclined downward relative to the direction of the normal line E′ of the display screen 101a.

Further, in this embodiment, the display device 100 of the laptop PC 10 is described as an example of a display device. However, the display device including the light receiving window and the illuminance sensor as described above is not limited to the display device 100 of the laptop PC 10. For example, such a display device may also be applied to, for example, a display device used in a desktop personal computer, a general television set and the like.

Next, a surrounding structure of the sub screen 205 of FIG. 1 is described.

The sub screen 205 is a display screen of a liquid crystal panel similar to the display screen 101a, and displays an image of the following auxiliary information. The auxiliary information may include, for example, icon information that may not be displayed on the display screen 101a and instruction information instructing the expansion and the movement of an image displayed on the display screen 101a.

The information processing circuit of the main body device 200 generates not only the information to be displayed on the display screen 101a and the like but also the auxiliary information. In this embodiment, by providing the sub screen 205, for example, it is intended to improve the visibility of the display screen 101a and facilitate the operations of the image information displayed on the display screen 101a.

Further, as described above, the sub screen 205 may also serve as an input operation surface where information is input by a contacting operation using the operation pen 206.

In this example, the sub screen 205 is integrated as a part of the inclined surface 211b inclined forward relative to the basic flat surface 211a.

Here, before the surrounding structure of the sub screen 205 in this embodiment is described, a second comparative example is described to compare with this embodiment.

In the laptop PC in the second comparative example, the integration manner of the sub screen differs from that in the laptop PC 10 in this embodiment.

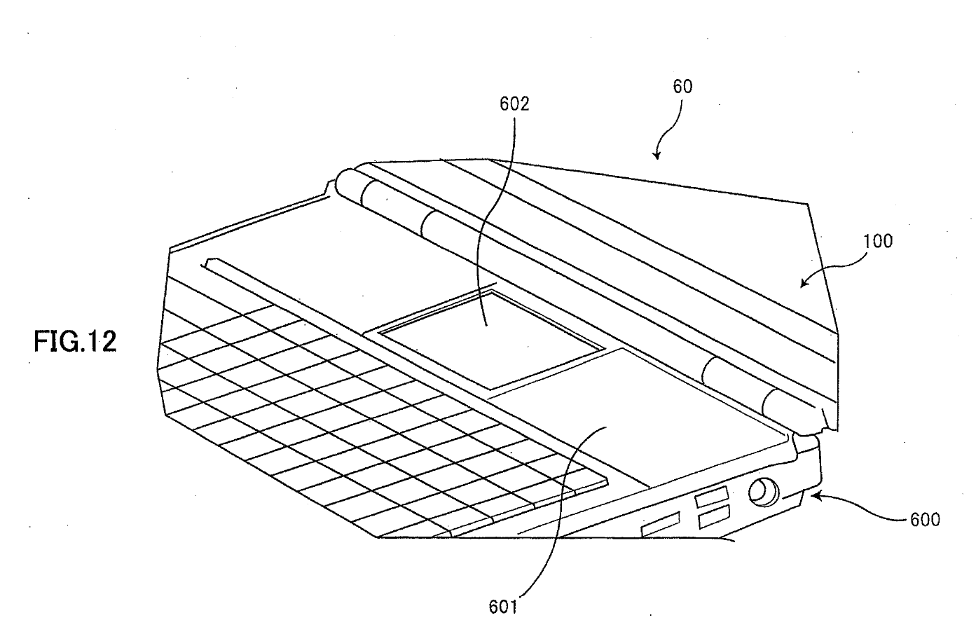

FIG. 12 is a schematic view of a laptop PC according to the second comparative example.

In FIG. 12, the same reference numerals are used to describe the same or equivalent elements in the configuration of the laptop PC 10 in this embodiment as illustrated in FIG. 1 and the like, and the repeated description thereof may be omitted.

In a laptop PC 60 in this second comparative example, an upper surface 601 of a main body device 600 is formed as a surface having mostly the same flat surface. Further, a sub screen 602 is integrated as a part of the upper surface 601 on the display device 100 side of the upper surface 601.

Here, generally, a laptop PC is used while the main body device is horizontally placed. Therefore, the user of the laptop PC 60 may see the sub screen 602 at a shallow angle. The sub screen 602 is a liquid crystal panel. Therefore, if the user has to see the sub screen 602 at a shallow angle, the angle may be out of the viewing angle of the liquid crystal panel. As a result, in the laptop PC 60 in this second comparative example, the visibility of the sub screen 602 is more likely to be degraded.

On the other hand, unlike the second comparative example, in the laptop PC 10 in this embodiment, the sub screen 205 is inclined forward relative to the basic flat surface 211a. Therefore, the angle at which the user sees the sub screen 205 may be deeper than that in the second comparative example. As a result, the angle at which the user sees the sub screen 205 is more unlikely to be out of the viewing angle of the sub screen 205.

Further, in this embodiment, due to the feature that the angle at which the user sees the sub screen 205 is more unlikely to be out of the viewing angle of the sub screen 205, a general liquid crystal panel having a general viewing angle is used.

Further, in this embodiment, the inclined sub screen 205 as described above is achieved by a simple configuration that the sub screen 205 is integrated as a part of the inclined surface 211b.

Further, in this embodiment, various parts and the like as described above are mounted on the inclined surface 211b adjacent to the sub screen 205.

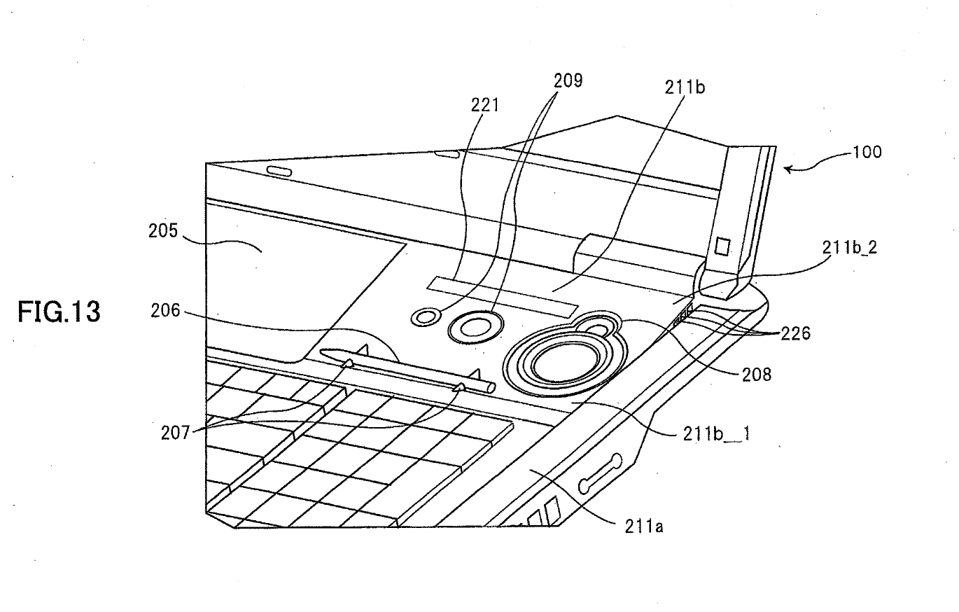

FIG. 13 is an enlarged view of inclined surface 211b adjacent to the sub screen 205.

As illustrated in FIGS. 1 and 13, on the inclined surface 211b adjacent to the sub screen 205, the speakers 208, the various types of operation buttons 209 and the camera 221 are provided as described above.

Therefore, the speakers 208 are provided on the inclined surface 211b inclined to the user side. In this embodiment, as a result, the sound from the speakers 208 is more likely to be heard by the user more clearly. Further, the various types of operation buttons 209 are provided on the inclined surface 211b inclined as described above, the operability of the various types of operation buttons 209 may be improved. Further, it may also become easier for the camera 221 to capture a subject to be shot such as the face of the user within the angle of view of the camera 221.

Here, as described above, the inclined surface 211b is more inclined forward than the basic flat surface 211a is. Further, an end part 211b_1 which is a front-side end (part) of the inclined surface 211b is positioned on the lower side of the main body device 200 lower than the basic flat surface 211a (i.e., the end part 211b_1 is lower than the basic flat surface 211a).

Further, a concave part generated by the position of the end part 211b_1 inside the main body device 200 is used as the storage part 207 storing the operation pen 206. As a result, the operation pen 206 may be stored at a position that its use may easily be recognized.

On the other hand, in this embodiment, the basic flat surface 211a is used as the area where the keyboard 201 is provided. Namely, the keyboard 201 is provided along the basic flat surface 211a. Due to the combination of the layout of the keyboard 201 and the inclination of the sub screen 205, the user may operate the keyboard 201 while seeing the sub screen 205 with sufficient visibility.

Further, the storage part 207 is provided in a manner that, when the laptop PC 10 is closed while the operation pen 206 is stored in the storage part 207, the operation pen 206 does not interfere with the display device 100.

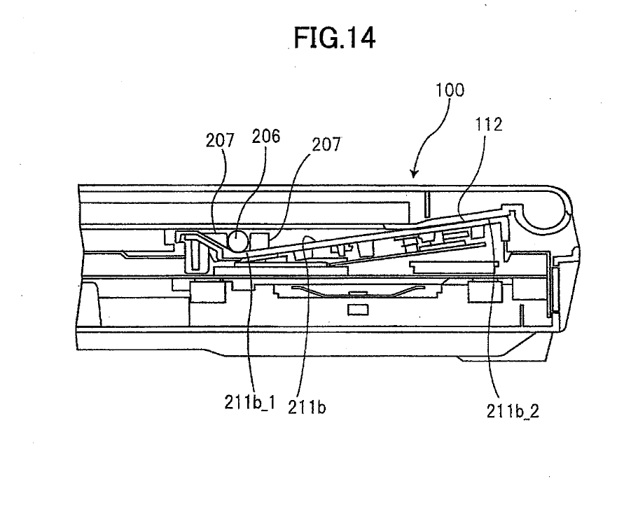

FIG. 14 is a cross-sectional view of a surrounding structure of the storage part 207 storing the operation pen when cut along the line H-H of FIG. 2 when the laptop PC is closed.

As illustrated in the cross-sectional view of FIG. 14, even when the laptop PC is closed, there still exists a gap (space) between the end part 211b_1 which is the front side of the inclined surface 211b disposed inside the main body device 200 and the display device 100.

The storage part 207 is provided in the gap, and the operation pen 206 is stored in the storage part 207 so as not be interfere with the display device 100 even when the laptop PC is closed.

Further, in this embodiment, to effectively use the gap between the end part 211b_1 which is the front side of the inclined surface 211b disposed inside the main body device 200 and the display device 100, the storage part 207 is provided in this gap. However, it is not always necessary to provide the storage part 207.

Further, as illustrated in the cross-sectional view of FIG. 14 and the perspective view of FIG. 13, in this embodiment, an end part 211b_2 which is the back side of the inclined surface 211b is positioned on the outer side of the main body device 200 when compared with the position of the basic flat surface 211a.

Here, in this embodiment, as described above, the second surface part 112 of the display device 100 is an inclined surface so that the lower end part of the second surface part 112 is shifted to the back side (backward) relative to the display screen 101a. As a result, a concave part is formed on the display device 100. When the laptop PC 10 is closed, the end part 211b_2 that is the back side of the inclined surface 211b and that is positioned at the outer side of the main body device 200 as described above is entered into the concave part of the display device 100.

By doing this, a part of the space of the main body device 200 in the thickness direction is shared (absorbed) by the display device 100. As a result, it may become possible to reduce the increase of the entire lap top PC 10 in the thickness direction.

Further, as illustrated in FIG. 13, in this embodiment, plural inclined-side-surface air inlet ports 226 are formed on a side surface connected to the end part 211b_2 which is the back side of the inclined surface 211b positioned at outer side of the main body device 200.

Further, in this embodiment, similar to the plural inclined-side-surface air inlet ports 226 formed not only on the side surface on the right side of the inclined surface 211b in FIG. 13, the plural inclined-side-surface air inlet ports 226 are also formed on the side surface on the left side of the inclined surface 211b.

Further, in this embodiment, plural inclined-back-surface air inlet ports described below are formed on the back surface connected to the end part 211b_2 which is the back side of the inclined surface 211b.

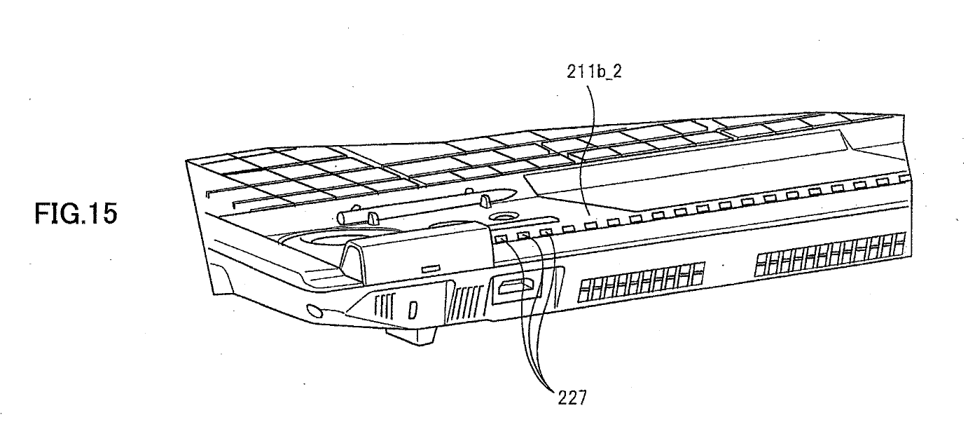

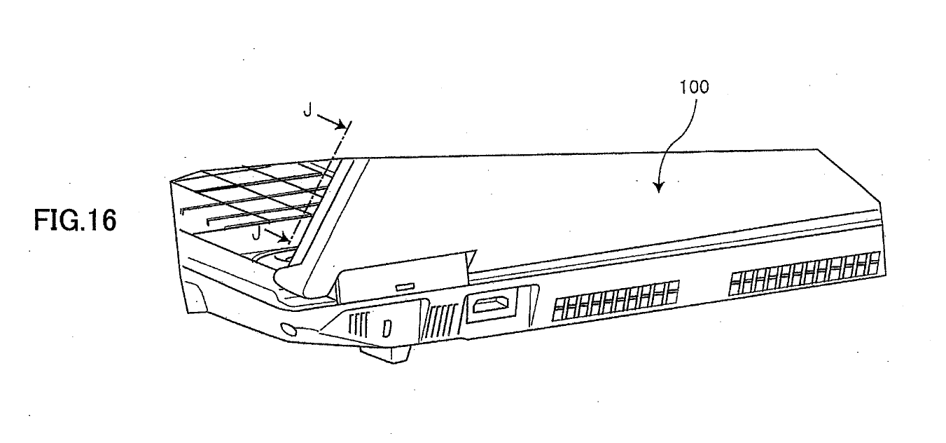

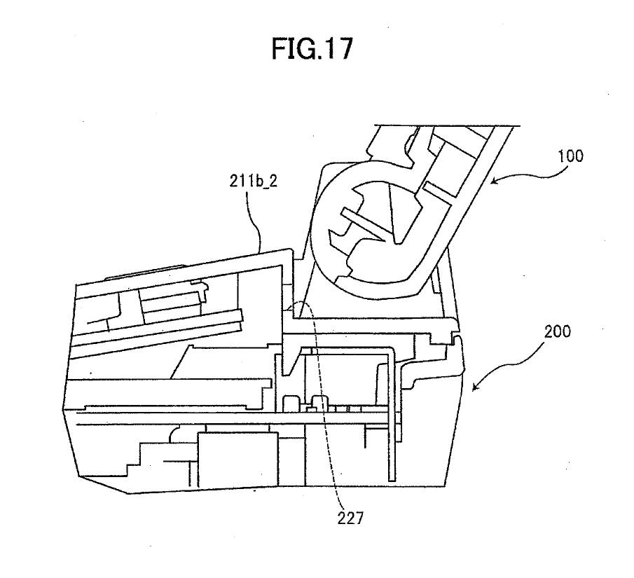

FIG. 15 is a perspective view of the main body device 200 from which the display device 100 is removed so that the plural inclined-back-surface air inlet ports 227 are exposed. FIG. 16 is a perspective view of the laptop PC in a state where the plural inclined-back-surface air inlet ports 227 are hidden by the display device 100. FIG. 17 is a cross-sectional view of an area near the inclined-back-surface air inlet ports 227 on the inclined back surface when cut along the line J-J of FIG. 16.

As illustrated in FIG. 15, the inclined-back-surface air inlet ports 227 are arranged on the back surface connected to the end part 211b_2 which is the back side of the inclined surface 211b. As illustrated in FIG. 16, apparently, those inclined-back-surface air inlet ports 227 are hidden by the display device 100 when the laptop PC 10 is in the opened state.

However, as illustrated in FIG. 17, there exist a gap (space) between the back surface connecting to the end part 211b_2 which is the back side of the inclined surface 211b and the display device 100. Therefore, air introduced through the inclined-back-surface air inlet ports 227 and passed through the gap is further introduced into the inside of the main body chassis 210.

As described above, in this embodiment in addition to the bottom-surface air input ports 222 and the back-surface air inlet ports 223, the inclined-side-surface air inlet ports 226 and the inclined-back-surface air inlet ports 227 are formed, the inclined-side-surface air inlet ports 226 being provided using the protrusion of the end part 211b_2 which is the back side of the inclined surface 211b. By additionally having those air inlet ports, the cooling efficiency inside the main body chassis 210 may be improved.

Further, in this embodiment, a case is described where the openings formed on the space generated by the inclined surface 211b (i.e., the inclined-side-surface air inlet ports 226 and the inclined-back-surface air inlet ports 227) are used as the air inlet ports. However, the openings may alternatively be used as the air outlet ports.

Further, in this embodiment, to effectively use the space generated by forming the inclined surface 211b, the inclined-side-surface air inlet ports 226 and the inclined-back-surface air inlet ports 227 are formed. However, it may not always be desired to form the inclined-side-surface air inlet ports 226 and the inclined-back-surface air inlet ports 227.

Further, in this embodiment, as an example of the electronic device including the sub screen as described above, the main body device 200 of the laptop PC 10 is described. However, the electronic device as described above is not limited to the main body device 200 of the laptop PC 10. Namely, the electronic device as described above may be, for example, a personal computer which is operated while a user views the display image on the display device separate from the personal computer.

Further, in this example, the light receiving window 102 described above is included in the display device 100. As described above, this configuration is provided to, for example, reduce the reception of light from the ceiling light UL and the display screen 101a into the light receiving window 102.

However, if it is not (necessarily) considered the influence of the reception of light from the ceiling light UL or the display screen 101a, the light receiving window 102 may be formed (disposed) on, for example, the inclined surface 211b of the main body device 200.

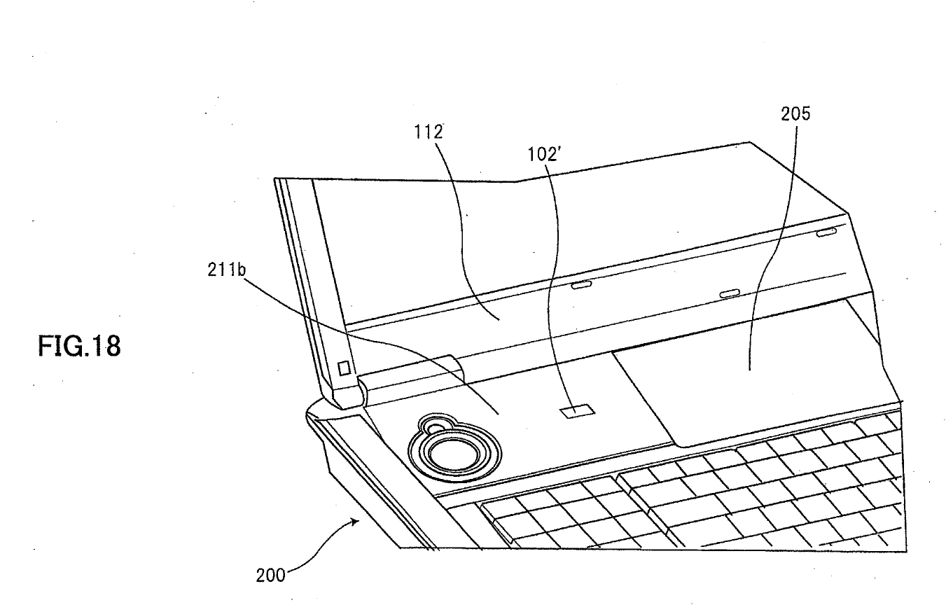

FIG. 18 is an enlarged perspective view illustrating the case where the light receiving window 102′ is formed on the inclined surface 211b of the main body device 200.

In this example of FIG. 18, on the inclined surface 211b, a part on the left side of the sub screen 205 is used as a space where the light receiving window 102′ is formed. Further, in this example, the illuminance sensor (not shown) is disposed on the rear (deeper) side in the main body device 200.

Next, details of the structure surrounding light emitting windows indicating a state of the laptop PC 10 by using LED-emitted light from the main body device 200 are described, the light emitting windows being formed on the front surface 212 of the main body chassis 210 in the area B defined by the dotted line of FIG. 1.

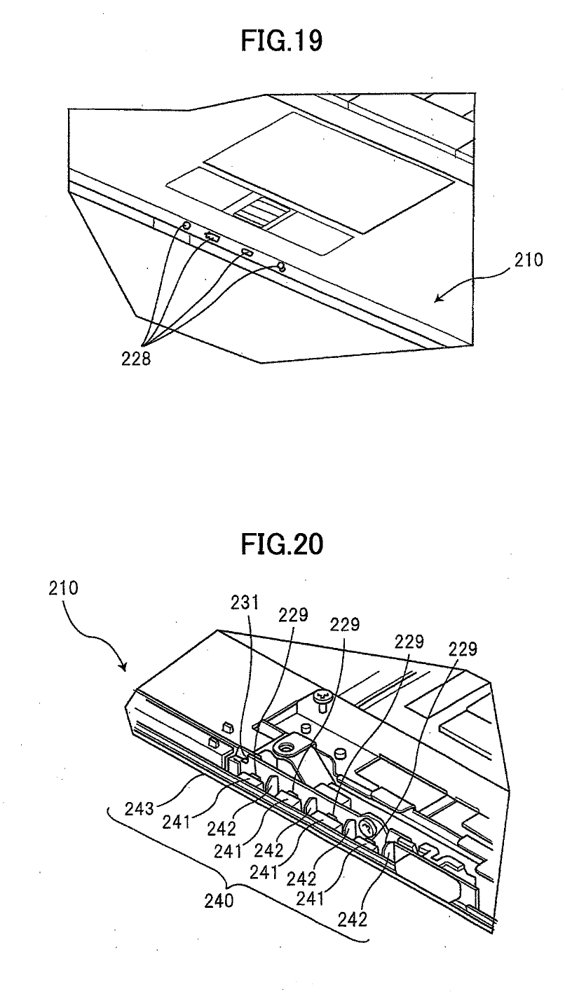

FIG. 19 is an enlarged view of the area B defined by the dotted line of FIG. 1.

As illustrated in FIG. 19, in this embodiment, there are four types of light emitting windows 228 formed on the side surface on the front side of the main body chassis 210. Further, which of the states of the laptop PC 10 is indicated (expressed) by the light emitting windows 228 is determined depending on the figure of the light emitting window 228 which is turned on.

Next, an internal structure surrounding the light emitting windows 228 in the main body device 200 is described.

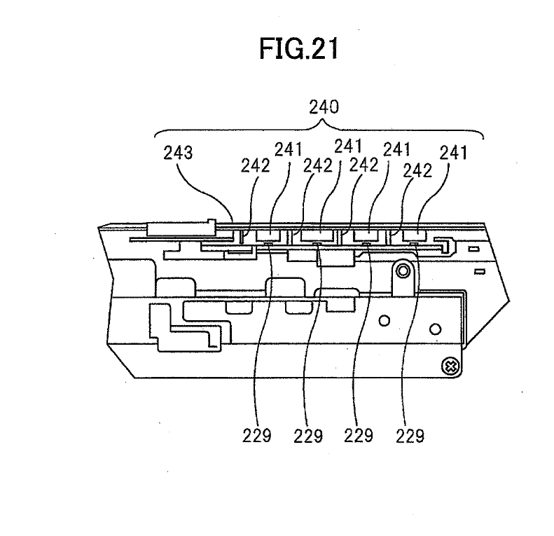

FIG. 20 is a perspective view illustrating an internal structure of an area near the light emitting windows 228. FIG. 21 is a top view illustrating the internal structure of the area near the light emitting windows 228.

In the main body device 200, an LED substrate 231 having a surface on which four LEDs 229 separated from each other are arranged and mounted is provided in a manner such that the surface on which the four LEDs 229 are mounted face the outside of the main body device 200.

Further, in the main body device 200, there is provided a light guiding member 240 to guide the light emitted from the LEDs 229 to the corresponding light emitting windows 228.

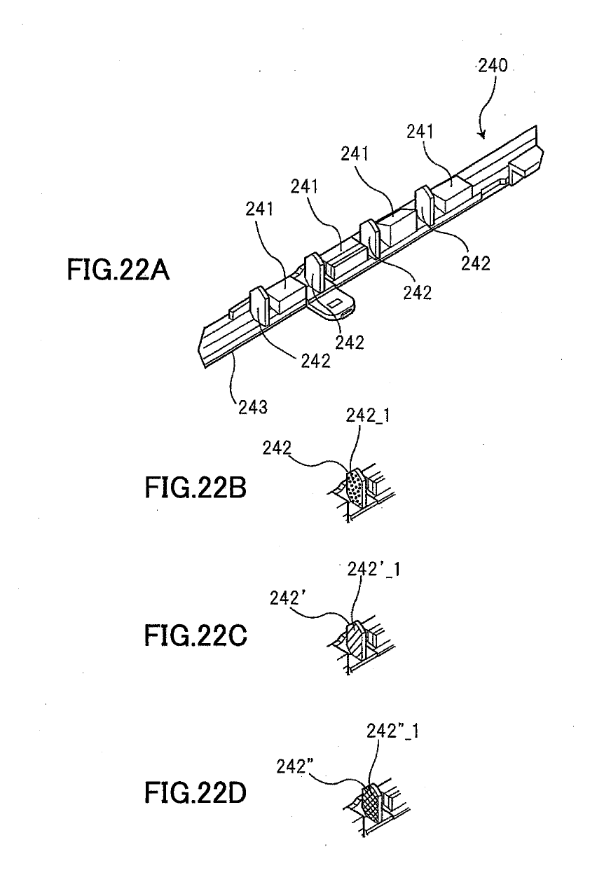

FIG. 22A is a perspective view of the light guiding member 240 alone when viewed from the LED substrate 231 side.

As illustrated in FIGS. 20 and 21, the light guiding member 240 includes four light guiding bodies 241 and three light shielding walls 242 which are alternately connected on a connecting part 243 so that the four light guiding bodies 241, the three light shielding walls 242, and the connecting part 243 are integrated into a single body.

FIG. 22A perspectively illustrates the light guiding member 240 including the entire of the four light guiding bodies 241 and the three light shielding walls 242.

The light guiding bodies 241 protrude toward the corresponding LEDs 229 so as to guide the light emitted from the LEDs 229 along the protruding direction of the light guiding bodies 241. The light shielding walls 242 are disposed between the light guiding bodies 241 adjacent to each other of the four light guiding bodies 241, so that the light shielding wall 242 prevents the transmission of light by a surface of the light shielding wall 242, the surface facing the light guiding body 241.

Further, the connecting part 243 alternately connects between the four light guiding bodies 241 and the three light shielding walls 242 arranged on a line. In this embodiment, the connecting part 243, and the four light guiding bodies 241 and the three light shielding walls 242 arranged on the line are integrally formed by using a resin material or the like to form the light guiding member 240. Namely, the light shielding walls 242 and the connecting part 243 are formed by the same material as that of the light guiding bodies 241.

In this embodiment, the light guiding member 240 serves as a side wall on the front side of the main body chassis 210. Further, on the light guiding member 240, a plate processing is performed on a wall surface corresponding to the outer surface of the main body chassis 210.

Further, the plate at the positions where the light is guided to in the light guiding bodies 241 is removed in the corresponding shapes of the light emitting windows 228. By doing this, the light emitted from the LEDs 229 is guided to the light emitting windows 228, so that the light emitting windows 228 emits the light to the outside of the main body chassis 210.

Further, in this embodiment, a surface of the light shielding walls 242 of the light guiding member 240, the surface facing the light guiding body 241, is a rough surface so that the transmission of light may be prevented.

FIG. 22B is an enlarged view illustrating the light shielding wall 242 having a rough surface 242_1.

By having the rough surface 242_1, it may become possible to reduce the leakage of the light from an LED 229 to the light guiding bodies 241 and the light emitting windows 228 which are other than the light guiding body 241 and the light emitting window 228, respectively, corresponding to the LED 229.

Here, a third comparative example is described to be compared with this embodiment.

In the following, only the surrounding structure of the light emitting windows of the main body device may be focused and described.

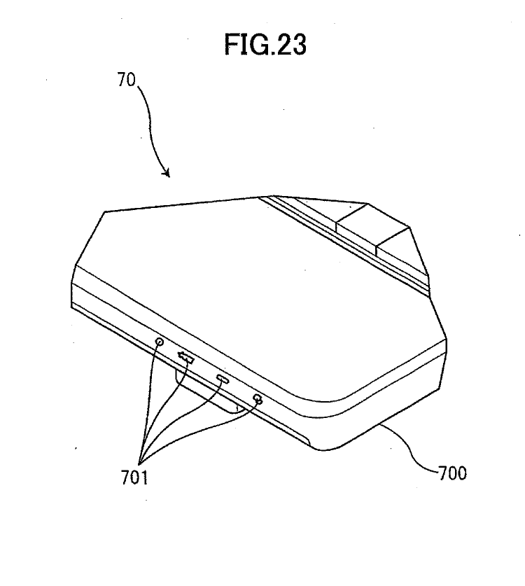

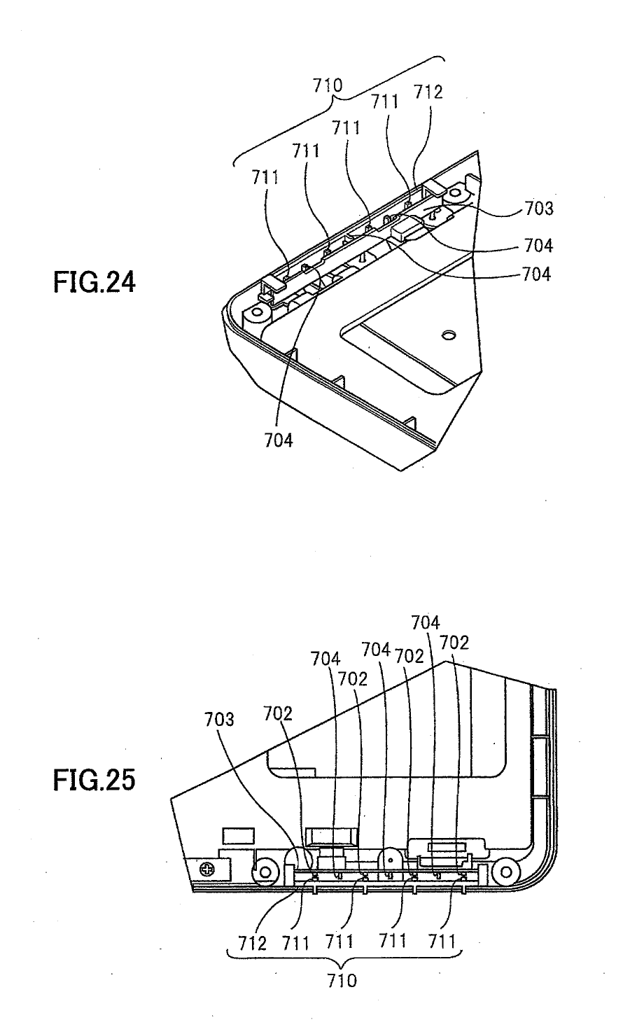

FIG. 23 is a perspective view illustrating light emitting windows according to the third comparative example. Further, FIG. 24 is a perspective view of an internal structure in an area near the light emitting windows in the third comparative example. Further, FIG. 25 is a top view of the internal structure in the area near the light emitting windows in the third comparative example.

In a laptop PC 70 in this third comparative example, four light emitting windows 701 are formed near the corner on the right side of the figures and the front side of a main body device 700.

Further, near the light emitting windows 701 of the main body device 700, an LED substrate 703 having a surface on which four LEDs 702 separated from each other are arranged and mounted is provided in a manner such that the surface on which four LEDs 702 are mounted faces the outside of the main body device 700.

Further, the main body device 700 includes a light guiding member 710 to guide the light emitted from the LEDs 702 to the corresponding light emitting windows 701.

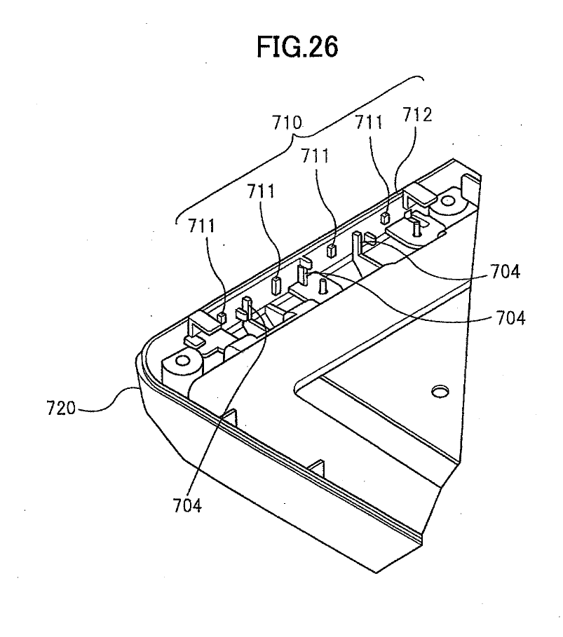

FIG. 26 is a perspective view of the internal structure in the area near the light guiding member 710 after an LED substrate is removed to make the light guiding member 710 more visible.

The light guiding member 710 includes four light guiding bodies 711 and a connecting part 712, as illustrated in FIGS. 24 and 25, which are connected to each other to be integrated. The light guiding bodies 711 protrude toward the corresponding LEDs 702 so as to guide the light from the LEDs 702 along the protrusion direction. Further, the connecting part 712 is integrated with the four light guiding bodies 711 and made of the same material as that of the four light guiding bodies 711.

Here, in the laptop PC 70 of this comparative example, there are also formed light shielding walls 704 to reduce the leakage of the light from an LED 702 to the light guiding bodies 711 and the light emitting windows 701 which are other than the light guiding body 711 and the light emitting window 701, respectively, corresponding to the LED 702.

However, the light shielding walls 704 are protruded from the bottom surface of a main body chassis 720. In this comparative example, the light guiding body 711 is a body different from the bodies of the light shielding walls 704, which makes the structure complicated. Therefore, due to, for example, a manufacturing error, the misalignment between the light guiding bodies 711 and the light shielding walls 704 may occur, and accordingly, the leakage of the light as described above may occur.

Further, due to the complicated structure between the light guiding body 711 and the light emitting window 701, it may become difficult when the space is desired to be reduced in the figure.

Unlike the configuration of the third comparative example as described above, in the laptop PC 10 in this embodiment, the light guiding bodies 241, the light shielding walls 242, and the connecting part 243 are integrated as a single body. Due to this configuration, it may become much easier to correctly adjust the positional relationship between the light guiding bodies 241, the light shielding walls 242 than in the third comparative example where the light guiding bodies 711 is a body different from the bodies of the light shielding walls 704.

As a result, it may become possible to more reliably prevent the leakage of the light as described above. Further, in this embodiment, by using the light guiding member 240 as described above, the inner configuration on the front surface 212 of the main body device 200 may be simplified. Therefore, it may become easier to respond to a request to reduce the space of the main body device 200 in the future.

Further, in this embodiment, as described above, the light guiding member 240 serves as the side wall on the front side of the main body chassis 210. By doing this, it may become possible to reduce the number of parts in the main body chassis 210 and the manufacturing cost. Further, in this embodiment, the light emitting windows 228 are formed by removing the plate at the positions where the light is guided to in the light guiding bodies 241. By doing this as well, the number of parts may be reduced and accordingly, the manufacturing cost may also be reduced.

Further, in this embodiment, the surface of the light shielding walls 242 is the rough surface 242_1 so that the transmission of light may be prevented. Therefore, the leakage of the light may be reduced. To form the rough surface 242_1, for example, when a mold of the entire light guiding member 240 is prepared, a rough surface is formed at the part corresponding to the rough surface 242_1 in the mold.

By doing this, when the mold is used to integrally form the light guiding member 240 using a resin material or the like, the rough surface 242_1 is simultaneously formed when the light guiding member 240 is formed. In this embodiment, from this point of view, the manufacturing cost may be reduced.

Here, as another method applied to light shielding walls 242 to reduce the leakage of the light, a plate process may be performed on the surfaces of the light shielding walls 242, the surfaces facing the light guiding bodies 241.

FIG. 22C is an enlarged view of a light shielding walls 242′ having a surface on which a plate 242′_1 is formed (placed).

The light shielding walls 242′ having a surface on which a plate 242′_1 is formed may have a higher light-shielding property, and the transmission of the light may be more reliably prevented (reduced).

Further, as still another method to reduce the leakage of the light, paint (coating material) to prevent (reduce) the transmission of the light may be applied on the surfaces of the light shielding walls 242, the surfaces facing the light guiding bodies 241.

FIG. 22D is an enlarged view of light shielding walls 242″ having a surface on which paint 242″_1 as describe above is applied.

The process of applying such paint 242″_1 may be easy. Therefore, the manufacturing cost may be reduced. Further, in the light shielding walls 242″, the application range of the paint may be arbitrarily determined, and further, the application range of the paint may also be changed (corrected) after the paint is once applied.

Further, in this embodiment, as an example of an electronic device including the light guiding member as described above, the main body device 200 of the laptop PC 10 is described. However, the electronic device is not limited to the main body device 200 of the laptop PC 10. Namely, for example, such an electronic device may be a desktop-type personal computer and a general electronic device including a display device using the emitted light of the LED.

Further, in this embodiment, the operating state of the laptop PC 10 is indicated by the shape of the light emitting window 228 which is turned on. However, for example, the shape of the light emitting windows 228 may be the same, and the operating state of the laptop PC 10 may be indicated by the colors of the light emitted from the LEDs corresponding to the light emitting windows 228.

Next, details of the inclined-surface air outlet ports 224 and the back-surface air outlet ports 225 formed on the main body chassis 210 as illustrated in FIG. 4 are described.

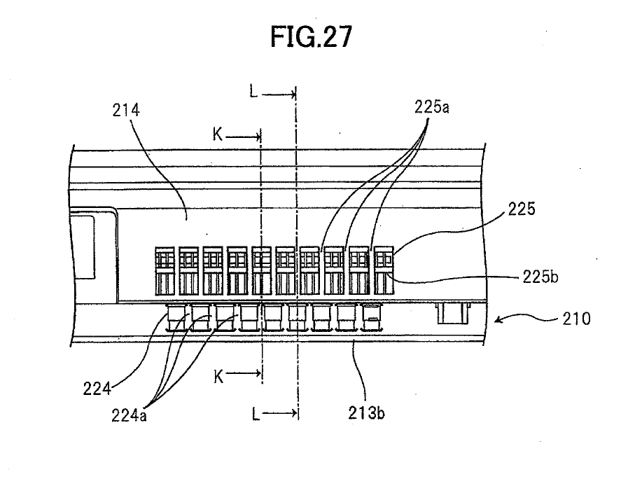

FIG. 27 is an enlarged view of the inclined-surface air outlet ports 224 and the back-surface air outlet ports 225 illustrated in FIG. 4.

As described above, in this embodiment, the inclined-surface air outlet ports 224 are formed on inclined surface extending from the second bottom surface part 213b to the back surface 214, the second bottom surface part 213b protruding on the outside side of the main body chassis 210 so as to ensure (provide) the space for containing the radiator and the like.

Further, the back-surface air outlet ports 225 are formed on the back surface 214. Further, the inclined-surface air outlet ports 224 and the back-surface air outlet ports 225 are formed vertically side by side on the outer surface of the main body chassis 210.

Here, the inclined-surface air outlet ports 224 are separated from each other by first ribs 224a disposed therebetween described below to reduce the deterioration of the (mechanical) strength of the main body chassis 210.

FIG. 28 is a cross-sectional view of an area near the inclined-surface air outlet ports 224 when cut along the line K-K passing through a first rib in FIG. 27.

FIG. 28 further illustrates a fan 251 and a radiator 252. The fan 251 generates an air flow (wind) in the main body chassis 210. The radiator 252 is disposed on the down stream side of the fan 251 in the air flow direction, and discharges (exhausts) heat collected from various parts of in the main body chassis 210 by the wind.

In this case, to contain the radiator 252 in a containing space of the main body chassis 210, the space may have to have a certain (sufficient) height in the thickness direction of the main body chassis 210. As described above, in this embodiment, to secure the containing space, a part of the bottom surface 213 is protruded to the outside of the main body chassis 210 beyond the first bottom surface part 213a which occupies more than half of the bottom surface 213. The part of the protruded bottom surface is the second bottom surface part 213b.

Further, the inclined-surface air outlet ports 224 is formed on the inclined surface extending from the second bottom surface part 213b to the back surface 214. Further, the back-surface air outlet ports 225 are formed on the back surface 214 and above the inclined-surface air outlet ports 224 in a manner such that the back-surface air outlet ports 225 and the inclined-surface air outlet ports 224 are arranged vertically side by side. Here, the inclined-surface air outlet ports 224 are separated from each other by the first ribs 224a disposed therebetween described below. FIG. 28 illustrates the cross-section of the first rib 224a.

The first ribs 224a extend in the vertical direction in the arranging direction of the inclined-surface air outlet ports 224 and the back-surface air outlet ports 225. Further, the end parts of the first ribs 224a on the back-surface air outlet ports 225 side (i.e., upper side) is disposed on the downstream side of the wind relative to the end parts opposite to the back-surface air outlet ports 225 side (i.e., lower side).

By having this structure, a part of the wind that has not been passed through the inclined-surface air outlet ports 224 may be pushed up by the first ribs 224a to the back-surface air outlet ports 225 side so as to be exhausted through the back-surface air outlet ports 225. As a result, it may become possible to effectively exhaust the wind heated by the radiator 252, thereby improving the cooling efficiency.

On the other hand, the back-surface air outlet ports 225 are separated from each other by second ribs 225a described below to reduce the deterioration of the strength of the main body chassis 210.

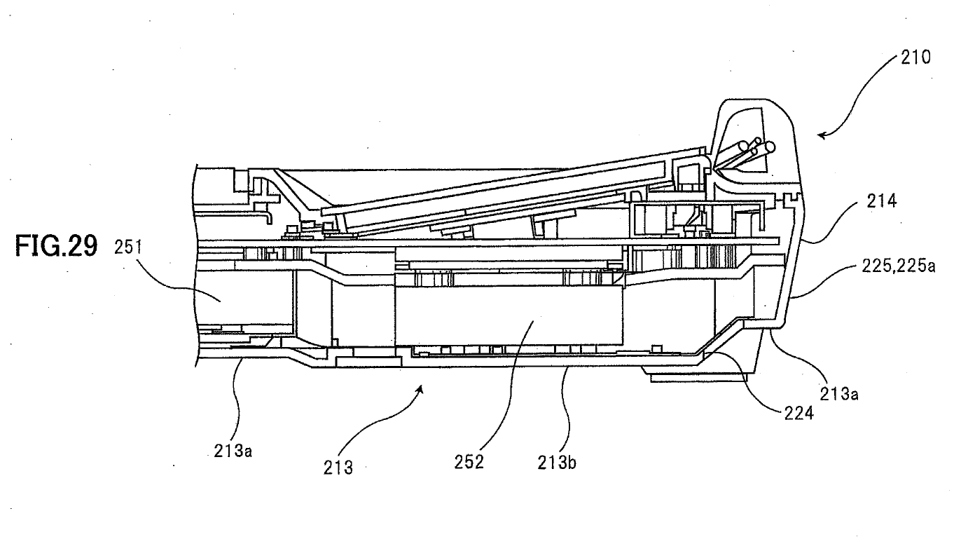

FIG. 29 is a cross-sectional view of an area near the back-surface air outlet ports 225 when cut along the line L-L passing through the second rib 225a in FIG. 27.

FIG. 29 illustrates a cross-section of the second rib 225a arranged on the back surface 214 and on the upper side of the corresponding inclined-surface air outlet port 224 and separating the adjacent back-surface air outlet ports 225.

The second ribs 225a extend in the vertical direction in the arranging direction of the inclined-surface air outlet ports 224 and the back-surface air outlet ports 225. Further, the second ribs 225a and the first ribs 224a separating the surface air outlet ports 224 are alternately arranged (in a zig-zag manner) as illustrated in FIG. 27. Namely, the second ribs 225a are disposed on the upper side of the corresponding inclined-surface air outlet ports 224 which are separated (formed) by the first ribs 224a.

By alternately arranged as described above (and as illustrated in FIG. 27), a wind (air flow) blown up by the first rib 224a may be smoothly discharged outside through the back-surface air outlet ports 225 without being interfered with the second ribs 225a. Accordingly, it may become possible to improve the cooling performance.

Further, in this embodiment, as illustrated in FIG. 27, in the back-surface air outlet ports 225 having a wide length in the thickness direction of the main body chassis 210, there are additionally formed third ribs 225b extending in the direction crossing the extending direction of the second ribs 225a so as to reinforce strength of the portions of the back-surface air outlet ports 225.

As described above, in this embodiment, to reinforce the (mechanical) strength, the third ribs 225b are formed in the back-surface air outlet ports 225. However, when, for example, sufficient strength may be obtained without the third ribs 225b, the third ribs 225b may not be provided (formed).

Here, a fourth comparative example is described to be compared with this embodiment.

In the following, only the air outlet ports of the main body device may be focused and described.

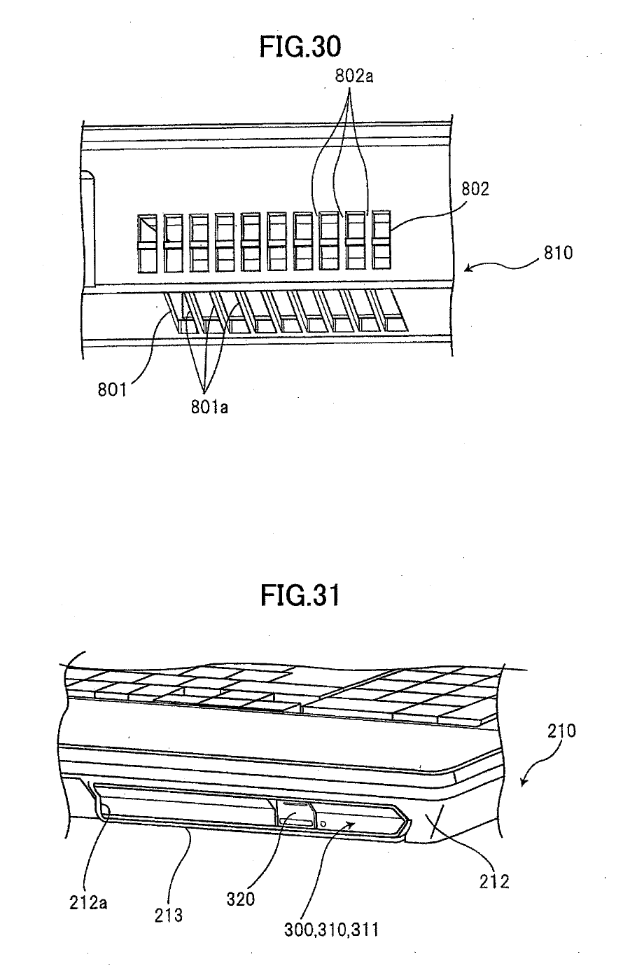

FIG. 30 is a view illustrating air outlet ports according to the fourth comparative example.

The fourth comparative example differs from this embodiment only in the positions of the second ribs 802a separating the back-surface air outlet ports 802 relative to the positions of the first ribs 801a separating the inclined-surface air outlet ports 224. Specifically, in the fourth comparative example, the second ribs 802a are disposed on the upper side of the corresponding first ribs 801a.

As a result, the wind (air flow) blown up by the first rib 801a may be interfered with by the second rib 802a; therefore, the efficiency of discharging the air flow may be reduced. Further, the second ribs 802a are provided on the same extending line as that of the corresponding first ribs 801a. Therefore, there may be no support between the second ribs 802a and between the first ribs 801a, which may reduce the (mechanical) strength at the air outlet ports of the main body chassis 810.

Unlike the fourth comparative example described above, in the laptop PC 10 in this embodiment, the second ribs 225a and the first ribs 224a are alternately arranged (in a zig-zag manner) as illustrated in FIG. 27. Therefore, the wind (air flow) may be more smoothly discharged and the discharge efficiency may be improved.

By alternately arranging in this way, the (mechanical) strength between the first ribs 224a may be reinforced by the second ribs 225a, and the (mechanical) strength between the second ribs 225a may be reinforced by the first ribs 224a. Namely, in this embodiment, it may become possible to improve the discharge efficiency while reducing the deterioration of the (mechanical) strength.

Further, in this embodiment, the inclined-surface air outlet ports 224 and the back-surface air outlet ports 225 are formed on the back side which is opposite to the front side where the keyboard 201 is provided (i.e., the opposite to the user side) in the main body chassis 210. Due to this configuration, the wind heated by the radiator 252 is discharged to the side opposite to the user side. Therefore, the user may have little discomfort.

Further, in this embodiment, the inclined-surface air outlet ports 224 is formed on the inclined surface extending from the second bottom surface part 213b to the back surface 214, the second bottom surface part 213b protruding outside of the main body chassis 210 so as to have the space for containing the radiator 252.

Namely, in this embodiment, the protruded shape of the bottom surface 213 (i.e., the second bottom surface part 213b) for cooling the main body chassis 210 is effectively used by the inclined-surface air outlet ports 224 so that the main body chassis 210 has an effective structure (configuration).

Further, in this embodiment, as an example of an electronic device having the air outlet port as described above, the main body device 200 of the laptop PC 10 is described. However, the electronic device as described above is not limited to the main body device 200 of the laptop PC 10. The electronic device as described above may be, for example, a desktop computer and a general electronic device including an air outlet port through which a wind is discharged from the inside of the device to the outside.

Next, details of a surrounding structure of the ODD 300 illustrated in FIG. 1 are described.

FIG. 31 is a perspective view illustrating a part near the ODD 300 of FIG. 1.

On the front surface 212 extending (rising) from the bottom surface 213 of the main body chassis 210, there is formed an opening 212a through which a disc (disk) tray 310 of the ODD 300 is movably contained in a back-and-forth direction. Further, in a state where the disc tray 310 is contained (in the main body chassis 210), the opening 212a is sealed by an outer side surface of a cover 311 of the disc tray 310.

Here, in the ODD 300, the disc tray 310 is biased toward the outside of the main body device 200 by a spring (not shown). In the state where the disc tray 310 is contained, the disc tray 310 is locked against the biasing force of the spring.

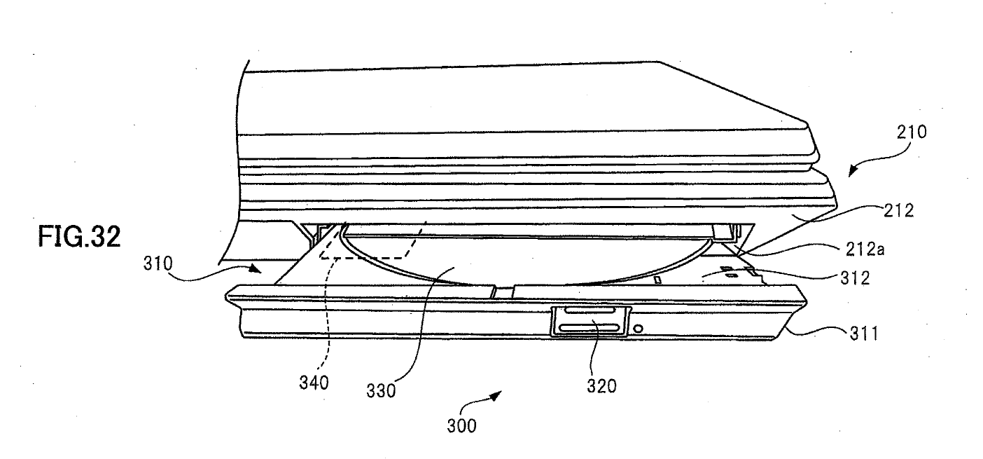

The ODD 300 includes an electronic circuit 340 (see FIG. 32) to release the lock. Further, on the outer side surface of a cover 311, there is provided a pressing button 320 to supply a signal to the electronic circuit 340 to eject the disc tray 310 when the pressing button 320 is pressed.

FIG. 32 is a drawing illustrating the laptop PC 10 in a state where the disc tray is ejected to the outside of the main body chassis 210 after the pressing button 320 is pressed.

The disc tray 310 includes a tray part 312 disposed on the main body chassis 210 side of the cover 311. Further, an optical disk 330 is mounted on the tray part 312 of the disc tray 310. Further, the electronic circuit 340 (see FIG. 32) to release the lock as described above is mounted in the tray part 312.

In the state where the disc tray 310 is contained, when the pressing button 320 is pressed, the signal to eject the disc tray 310 is supplied to the electronic circuit 340. Then, by releasing the lock by the electronic circuit 340, the disc tray 310 is ejected (pushed out) through the opening 212a on the front surface 212 by the biasing force of the spring.

Here, in this embodiment, the outer side surface of the cover 311 of the disc tray 310 and a pressing surface 321 of the pressing button 320 fixed to the outer side surface have the shapes as described below.

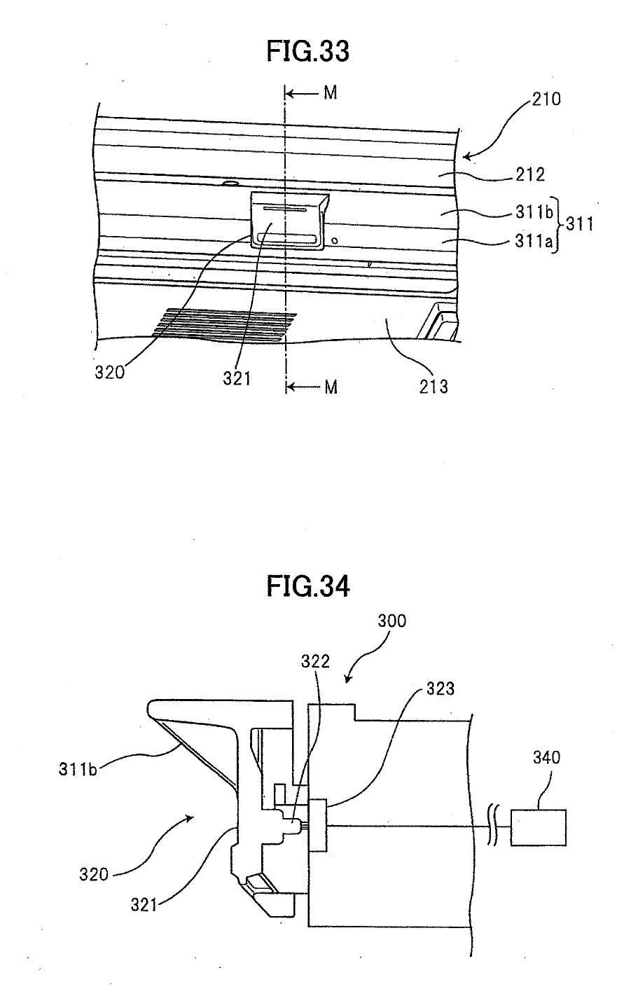

FIG. 33 is an enlarged view of a part near the pressing button 320 illustrated in FIGS. 31 and 32.

The outer side surface of the cover 311 of the disc tray 310 includes a first side surface 311a and a second side surface 311b, the first side surface 311a extending (rising) from the bottom surface 213 side of the main body chassis 210, the second side surface 311b disposed on the upper side of the first side surface 311a and connected to the first side surface 311a. Further, the second side surface 311b extends (protrudes) outside (forward) beyond the first side surface 311a (see FIG. 34).

Further, the pressing surface 321 of the pressing button 320 extends along the first side surface 311a in a manner such that a part of the pressing surface 321 is formed as a part of the first side surface 311a and another part of the pressing surface 321 is formed as a bottom of a concave part relative to the second side surface 311b.

FIG. 34 is a cross-sectional view of the pressing button 320 when cut along the line M-M of FIG. 33.

As is apparent from FIG. 34 and the like, the upper end part of the pressing surface 321 of the pressing button 320 serves (acts) as the bottom (part) of the concave part relative to the second side surface 311b. Further, an end part of the pressing button 320 is connected to the cover 311 of the disc tray 310, the end part being on the second side surface 311b side (i.e., the upper end) of the pressing button 320 in a form of a cantilever structure. Further, the pressing button 320 is bent when the pressing button 320 is pressed.

Further, on a rear surface opposite to the pressing surface 321 of the pressing button 320, a protrusion 322 protruding inside the ODD 300 is formed. Further, in the ODD 300, a contact point 323 facing the distal end of the protrusion 322 is provided. When the pressing button 320 is pressed and bent as described above, the protrusion 322 presses the contact point 323. By dong this the contact point is closed and the signal to eject the disc tray 310 is supplied to the electronic circuit 340.

Here, a fifth comparative example is described to compared with this embodiment.

In the following, only the pressing button provided on the cover of the disc tray of the ODD may be focused and described.

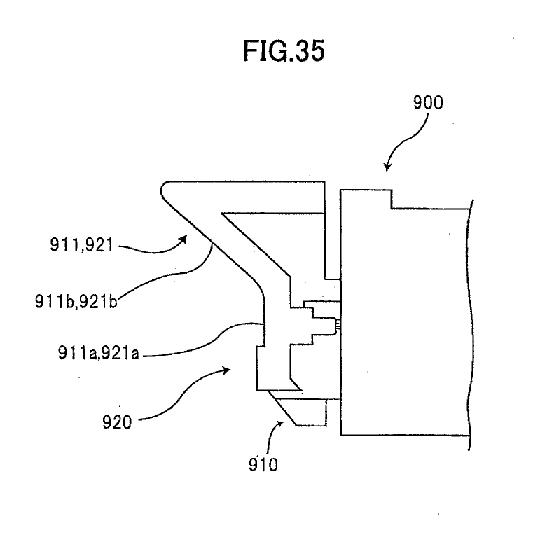

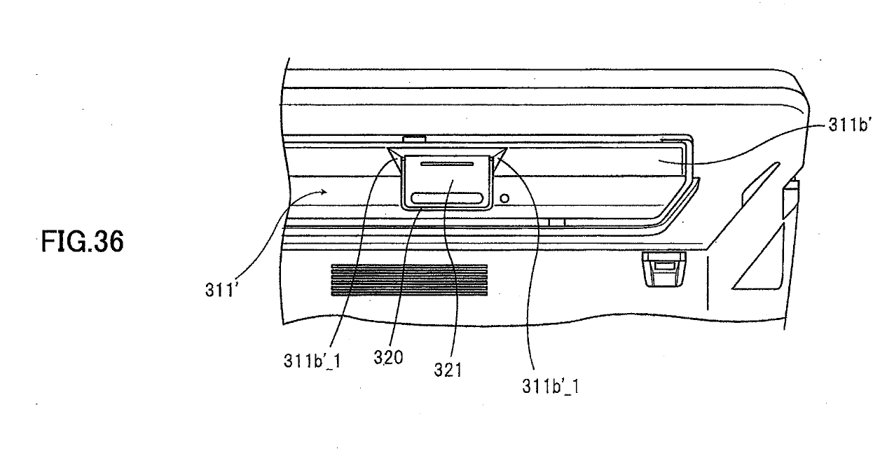

FIG. 35 is a cross-sectional view of the pressing button according to the fifth comparative example similar to FIG. 34.

In this fifth comparative example, the outer side surface of a cover 911 of a disc tray 910 of an ODD 900 includes a first side surface 911a and a second side surface 911b, the first side surface 911a extending (rising) from the bottom surface side of the main body chassis, the second side surface 911b disposed on the upper side of and connecting to the first side surface 911a. Further, the second side surface 911b extends (protrudes) outside (forward) beyond the first side surface 911a.

Further, most of a pressing surface 921 of a pressing button 920 is connected to the cover 911 so that the pressing surface 921 is formed as a part of the outer side surface of the cover 911. Namely, the pressing surface 921 includes a first pressing surface 921a which is a part of the first side surface 911a and a second pressing surface 921b which is a part of the second side surface 911b.

Here, the thickness of the front surface where the cover 911 of the disc tray 910 of the laptop PC is small. Therefore, it may be difficult for a user to see the pressing button 920 fixed to the cover 911 as described above. As a result, in many cases, a user may find the pressing button 920 by touching around and press the found pressing button 920. However, as in the fifth comparative example, namely, if the shape of the pressing surface 921 of the pressing button 920 is (substantially) the same as that of the outer side surface of the cover 911, it may be difficult to locate (find) the pressing button 92 even by touching around the outer side surface.

Unlike the fifth comparative example as described above, in the laptop PC 10 in this embodiment, the upper part of the pressing button 320 is formed as the bottom of the concave part relative to the second side surface 311b as described above. As a result, when a user touches around the second side surface 311b with a finger, the finger may easily detect a step (difference in height) formed between the pressing button 320 and the second side surface 311b. By doing this, it may become easier to locate and operate the pressing button 320.

Further, in this embodiment, the pressing button 320 is provided in the form of the cantilever structure as described above.

Here, in the fifth comparative example, the upper end of the pressing button 920 is connected to the cover so as form the cantilever structure as well. However, in the cantilever structure of the fifth comparative example, the upper end of the second pressing surface 921b connected to the cover 911 is protruding outside (forward).

Due to the protrusion, when the pressing button 920 is pressed, the pressing force is used to rotate the second pressing surface 921b relative to the upper end of the second pressing surface 921b and the pressing force may be hard to be transmitted and the second pressing surface 921b may be hard to be bent (pushed).

On the other hand, in this embodiment, the pressing button 320 includes the pressing surface 321 expanding along the first side surface 311a, and the upper end of the pressing surface 321 is connected to the cover 311. Due to this configuration, the upper end to be bent when the pressing button 320 is pressed is disposed at the position where the pressing force may be easily transmitted, so that the upper end may be bent easily.

Further, in this embodiment, the side surfaces of the concave part formed by the second side surface 311b and the pressing surface 321 are formed substantially orthogonal to the pressing surface 321. However, alternatively, the side surfaces of the concave part may be formed as described below.

FIG. 36 is a drawing illustrating another example of the concave part formed by a second side surface of the cover and the pressing surface.

In this example of FIG. 36, the side surfaces of the concave part formed by the second side surface 311b′ of the cover 311′ and the pressing surface 321′ is inclined surfaces 311b′_1 inclined from the second side surface 311b to the pressing surface 321. In this example, a finger of the user looking for the pressing button 320 touches the inclined surfaces 311b′_1 expanding in the peripheral part of the pressing button 320 as well. Namely, the range where the finger of the user can locate the pressing button 320 is enlarged. As a result, it may become much easier for the user to locate the pressing button 320.

Further, in this embodiment, as an example of an electronic device including a container having the pressing button as described above, the main body device 200 of the laptop PC 10 including the ODD 300 is described. However, the electronic device as described above is not limited to the main body device 200 of the laptop PC 10. Namely, the electronic device as described above may include a laptop PC and a desktop personal computer including a drive device on which a disk-shaped portable medium other than the optical disk is mounted.

The disk-shaped portable medium may include a Compact Disk Read-Only Memory (CD-ROM), a Digital Versatile Disc (DVD) and the like. Further, the electronic device described above is not limited to a computer. The electronic device may include a general electronic device including a drive device as described above such as a DVD player.

Here, in the laptop PC 10 in this embodiment, the ODD 300 is attachably and detachably mounted on the main body device 200 through the opening 212a on the front surface 212 through which the disc tray 310 of the ODD 300 is movably contained in a back-and-forth direction. The reason of this configuration is to respond to a request from the user to, for example, add the unmounted ODD 300 and replace an old mounted ODD with a new model of the ODD.

In the following, details of a mounting structure of the ODD 300 are described.

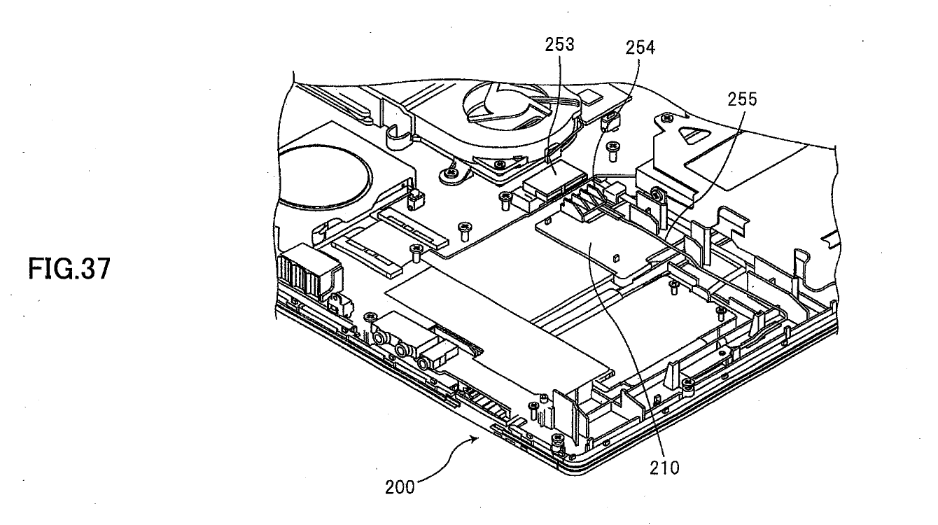

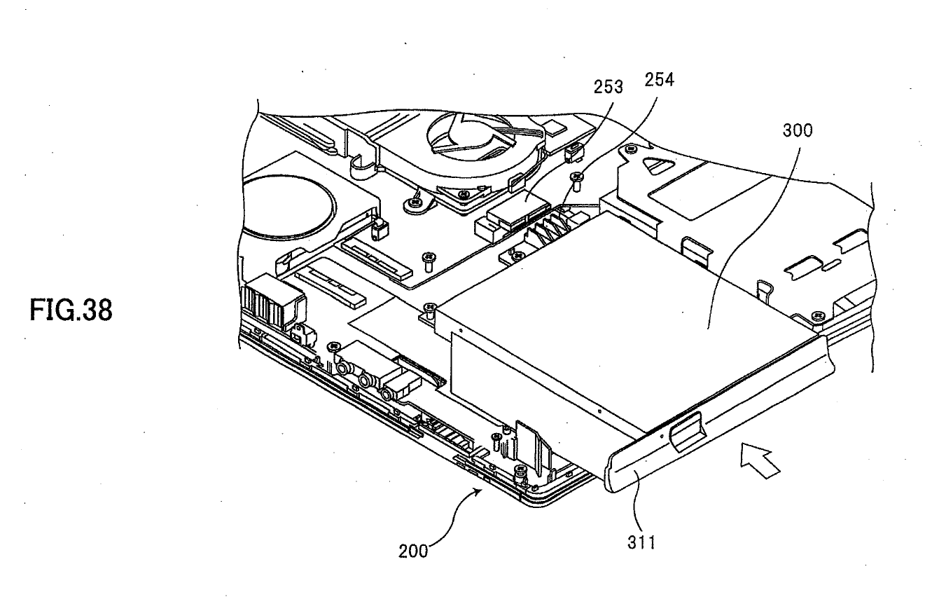

FIG. 37 is a drawing illustrating inside of the main body device 200 in which no ODD is mounted. FIG. 38 is a drawing where the ODD 300 is moved into the main body device 200.

In FIGS. 37 and 38, the main body device 200 is perspectively illustrated in a state where the main body device 200 is placed upside down as in FIG. 4 and a cover on the rear side and the like are removed. Further, in FIG. 38, the ODD 300 is also placed upside down similar to the main body device 200.

As illustrated in FIG. 38, the ODD 300 is mounted on the main body device 200 by inserting the ODD 300 through the opening 212a while the ODD 300 is disposed so that the cover 311 is directed to the front side of the main body device 200 (to be disposed farther from the opening 212a) and the back end opposite to the cover 311 is directed to the opening 212a (to be disposed closer to the opening 212a) so as to be inserted first into the main body device 200. On the back end (rear end) of the ODD 300, a male connector 350 (see FIG. 40) described below is provided.

On the other hand, in the main body device 200, as illustrated in FIGS. 37 and 38, there is provided a female connector 253 to be engaged with the male connector 350.

When the ODD 300 is mounted on the main body device 200 as described above, the male connector 350 on the ODD 300 side is engaged with the female connector 253 in the main body device 200. By doing this, the ODD 300 is electrically connected to the main body device 200.

Here, in the main body device 200, there is provided a guiding member 254 fixed to the main body device 200. The guiding member 254 guides the back end (rear end) of the ODD 300 to the female connector 253 so that the male connector 350 on the ODD 300 side is accurately (reliably) engaged with the female connector 253 in the main body device 200.

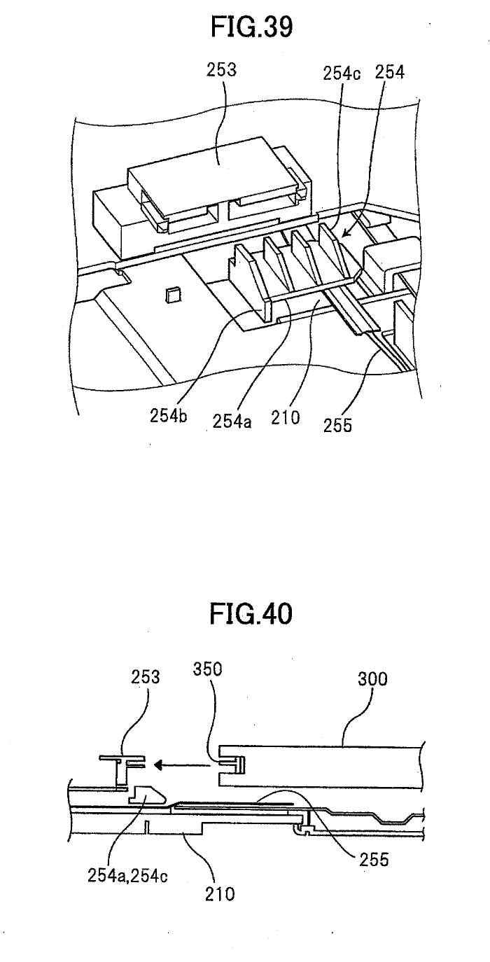

FIG. 39 is an enlarged view of a part including the guiding member 254 of FIGS. 37 and 38.

The guiding member 254 includes an extending part 254a and a holding part 254b as described below.

The extending part 254a extends in the direction orthogonal to the direction of inserting the ODD 300 and disposed so as to generate a gap between the main body device 200 and the ODD 300 when the back end (rear end) of the ODD 300 is in contact with the guiding member 254. Further, by contacting with the back end (rear end) of the ODD 300, the extending part 254a guides the back end (rear end) of the ODD 300 to the female connector 253 of the main body device 200. Further, the holding part 254b is in connection with one end of the extending part 254a so as to hold the extending part 254a at a fixed position relative to the main body chassis 210.

The guiding member 254 further includes plural ribs 254c on the extending part 254a. The ribs 254c extend toward the female connector 253 of the main body device 200. The ribs 254c include a inclined part where the height of the ribs 254c increase as the distance to the female connector 253 reduces. The back end (rear end) of the ODD 300 having been in contact with the extending part 254a and guided toward the female connector 253 is further reliably guided toward the female connector 253 by the plural ribs 254c.

Further, the shape (or the configuration) of the guiding member 254 may be adaptively changed. For example, although there are plural ribs 254c in this embodiment, the number of the rib 254c may be just one. Further, although the shape of the ribs 254c is a plate shape extending from the front surface side to the back surface side of the main body chassis 210 in this embodiment, for example, there may be formed an inclined surface expanding from the front surface side to the back surface side of the main body chassis 210 and expanding from the holding part 254b along the distal end of the extending part 254a as a base.

Here, in this embodiment, there is a cable 255 wired between the ODD 300 and the main body chassis 210. Further, as illustrated in FIG. 39, the cable 255 is held at the following position by being wired through a gap between the extending part 254a and the main body chassis 210.

FIG. 40 is a schematic view illustrating where the cable is held by the extending part 254a of the guiding member 254 and the ODD is inserted into the main body chassis 210.

As illustrated in FIG. 40, when the ODD 300 is inserted through the opening 212a as described above, the ODD 300 is inserted along the inserting path so that the cable 255 is sandwiched by the inserting path and the main body chassis 210. Then, the back end (rear end) of the ODD 300 is in contact with the extending part 254a and is directed (positioned) toward the female connector 253 by the plural ribs 254c. By doing this, the back end (rear end) of the ODD 300 is guided toward the female connector 253. As a result, the male connector 350 provided on the back end (rear end) of the ODD 300 is reliably engaged with the female connector 253.

In this case, if the cable 255 connecting between the ODD 300 and the main body chassis 210 is raised toward the inserting path side of the ODD 300 from the main body chassis 210 side, the cable 255 may be accidentally wound up by the ODD 300 during the movement of the ODD 300. Therefore, in this embodiment, the cable 255 is wired between the extending part 254a and the main body chassis 210. By wiring in this way, the cable 255 is held at the position separated from the inserting path of the ODD 300.

As a result, the rising of the cable 255 may be prevented and further, it may become possible to prevent the cable 255 from being wound up by the ODD 300 during the movement of the ODD 300. Therefore, according to this embodiment, it may become possible to mount the ODD 300 on the main body device 200 while preventing the cable 255 from being wound up by the ODD 300 (during the movement of the ODD 300).

Further, in this embodiment, as an example of an electronic device containing a mounting unit as described above, the main body device 200 of the laptop PC 10 including the ODD 300 is described. However, the electronic device described above is not limited to the main body device 200 of the laptop PC 10. Namely, the electronic device as described above may include a laptop PC and a desktop personal computer including a drive device on which a disk-shaped portable medium other than the optical disk is mounted.

The disk-shaped portable medium may include the CD-ROM, the DVD and the like. Further, the electronic device described above is not limited to a computer. The electronic device may include a general electronic device including a drive device as described above such as a DVD player.

Further, in this embodiment, as a unit to be connected with the main body device and having a connector to be mechanically and electrically contacted with a connector of the main body device, the ODD is described. However, such a unit (electrical device) is not limited to the ODD. The unit described above may include any other types of the unit such as a drive unit which is a portable medium other than the optical disk, a battery unit, a ten key unit and the like.

According to an embodiment, it may become possible to provide a display device in which an image is displayed at an appropriate brightness level and an electronic device including the display device.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiments of the present inventions has been described in detail, it is to be understood that various changes, substitutions, and alterations could be made hereto without departing from the spirit and scope of the invention.

What is claimed is:

1. A display device comprising:
a display module including a display screen and configured to display an image on the display screen;
a chassis configured to contain the display module, expose the display screen, and hold the display screen so as to stand the display screen;
a light receiving window disposed on a first part on the chassis, the first part being adjacent to a second part where the display screen is exposed, shifted toward a back side from a surface of the chassis on a periphery of the second part, and configured to receive incident light from outside of the chassis into the chassis; and
an illumination sensor contained in the chassis, configured to detect illuminance of incident light through the light receiving window, and having an illuminance detection range having a center line extending in a direction inclined downward from a direction of a normal line of the display screen.

2. The display device according to claim 1,
wherein the chassis includes a chassis surface circumferentially surrounding the second part and
wherein the chassis surface includes a first surface part and a second surface part, the first surface part facing a direction along the direction of the normal line of the display screen, the second surface part facing a direction inclined downward from the direction of the normal line of the display screen, and
wherein the light receiving window is formed on the second surface part.

3. The display device according to claim 1,
wherein the light receiving window is configured to receive the incident light from an incident range facing along a center line inclined downward from the direction of the normal line of the display screen, and
wherein the incident range corresponds to the illuminance detection range of the illumination sensor.

4. The display device according to claim 1, further comprising:
a light guiding body extending from the light receiving window to the illumination sensor and configured to guide the incident light received through the light receiving window,
wherein the light receiving window is configured to receive the incident light from an incident range facing along a center line inclined downward from the direction of the normal line of the display screen.

5. The display device according to claim 1,
wherein the light receiving window is disposed on the lower side of the second part where the display screen is exposed.

6. An electronic device comprising:
a display device including
a display module including a display screen and configured to display an image on the display screen,
a chassis configured to contain the display module, expose the display screen, and hold the display screen so as to stand the display screen,
a light receiving window disposed on a first part on the chassis, the first part being adjacent to a second part where the display screen is exposed, shifted toward a back side from a surface of the chassis on a periphery of the second part, and configured to receive incident light from outside of the chassis into the chassis, and
an illumination sensor contained in the chassis, configured to detect illuminance of incident light through the light receiving window, and having an illuminance detection range having a center line extending in a direction inclined downward from a direction of a normal line of the display screen; and
a main body device to which the display device is openably and closeably connected.
